(19) United States
(12) Patent Application Publication
(10) Pub. No.: US 2020/0117106 A1
(43) Pub. Date: Apr. 16, 2020

(54) COMPOUND MIXTURE, ELECTROPHOTOGRAPHIC PHOTOSENSITIVE MEMBER AND PRODUCTION METHOD FOR COMPOUND MIXTURE

(71) Applicant: KYOCERA Document Solutions Inc., Osaka (JP)

(72) Inventors: Jun AZUMA, Osaka-shi (JP); Kensuke KOJIMA, Osaka-shi (JP); Tomofumi SHIMIZU, Osaka-shi (JP)

(73) Assignee: KYOCERA Document Solutions Inc., Osaka (JP)

(21) Appl. No.: 16/593,093

(22) Filed: Oct. 4, 2019

(30) Foreign Application Priority Data
Oct. 10, 2018 (JP) 2018-191674

(51) Int. Cl. G03G 5/06

(52) U.S. Cl. CPC G03G 5/0614; G03G 5/0616; G03G 5/0651; G03G 5/0605

(57) ABSTRACT

A compound mixture contains a mixture of a compound represented by general formula (1) and a compound represented by general formula (2). In the general formula (1), R^{1A}, R^{2A}, R^{3A}, R^{4A}, R^{5A}, R^{6A}, R^{7A}, R^{8A}, R^{9A}, and R^{10A} each represent, independently of one another, a hydrogen atom, an alkyl group having a carbon number of at least 1 and no greater than 8, an alkoxy group having a carbon number of at least 1 and no greater than 8, or an aryl group having a carbon number of at least 6 and no greater than 14. Y represents a bivalent group represented by chemical formula (Y1), chemical formula (Y2), or general formula (Y3):

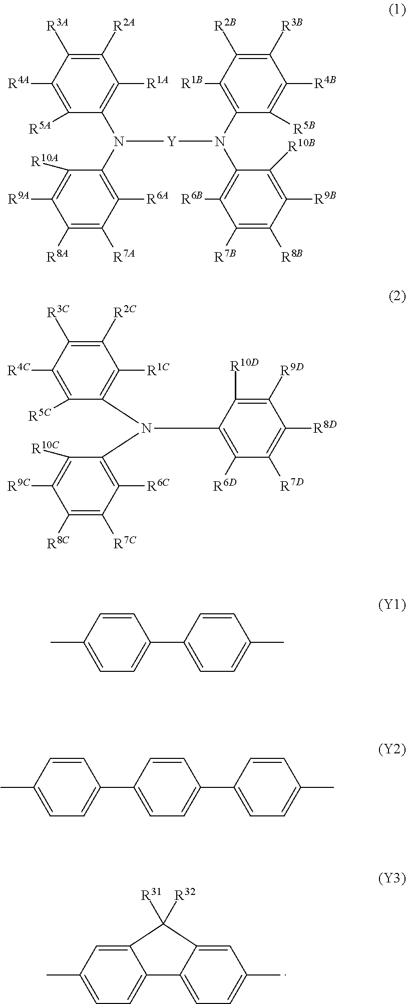

### INCORPORATION BY REFERENCE

The present application claims priority under 35 U.S.C. § 119 to Japanese Patent Application No. 2018-191674, filed on Oct. 10, 2018. The contents of this application are incorporated herein by reference in their entirety.

### BACKGROUND

The present disclosure relates to a compound mixture, an electrophotographic photosensitive member, and a production method for a compound mixture.

An electrophotographic photosensitive member is used as an image bearing member in an electrophotographic image forming apparatus (such as a printer or a multifunction peripheral). The electrophotographic photosensitive member includes a photosensitive layer. The photographic photosensitive member can be, for example, a single-layer electrophotographic photosensitive member or a multi-layer electrophotographic photosensitive member. The single-layer electrophotographic photosensitive member includes a single-layer photosensitive layer having both a charge generation function and a charge transport function. The multi-layer electrophotographic photosensitive member includes a photosensitive layer including a charge generation layer having a charge generation function and a charge transport layer having a charge transport function.

For example, a known electrophotographic photosensitive member includes a photosensitive layer provided on a conductive substrate and containing, as a charge transport material, a diamine derivative having a specific structure and 1,1-bis(p-diethylaminophenyl)-4,4-diphenyl-1,3-butadiene.

### SUMMARY

A compound mixture according to an aspect of the present disclosure contains a mixture of a compound represented by general formula (1) and a compound represented by general formula (2):

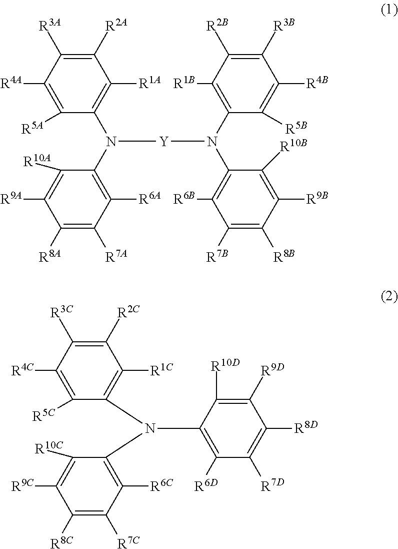

In the general formula (1), R^{1A}, R^{2A}, R^{3A}, R^{4A}, R^{5A}, R^{6A}, R^{7A}, R^{8A}, R^{9A}, and R^{10A} each represent, independently of one another, a hydrogen atom, an alkyl group having a carbon number of at least 1 and no greater than 8, an alkoxy group having a carbon number of at least 1 and no greater than 8, or an aryl group having a carbon number of at least 6 and no greater than 14. R^{1B} in the general formula (1) and R_{1C} in the general formula (2) represent the same group as R^{1A} in the general formula (1). R^{2B} in the general formula (1) and R^{2C} in the general formula (2) represent the same group as R^{2A} in the general formula (1). R^{3B} in the general formula (1) and R^{3C} in the general formula (2) represent the same group as R^{3A} in the general formula (1). R^{4B} in the general formula (1) and R^{4C} in the general formula (2) represent the same group as R^{4A} in the general formula (1). R^{5B} in the general formula (1) and R^{5C} in the general formula (2) represent the same group as R^{5A} in the general formula (1). R^{6B} in the general formula (1) and R^{6C} and R^{6D} in the general formula (2) represent the same group as R^{6A} in the general formula (1). R^{7B} in the general formula (1) and R^{7C} and R^{7D} in the general formula (2) represent the same group as R^{7A} in the general formula (1). R^{8B} in the general formula (1) and R^{8C} and R^{8D} in the general formula (2) represent the same group as R^{8A} in the general formula (1). R^{9B} in the general formula (1) and R^{9C} and R^{9D} in the general formula (2) represent the same group as R^{9A} in the general formula (1). R^{10B} in the general formula (1) and R^{10C} and R^{10D} in the general formula (2) represent the same group as R^{10A} in the general formula (1). Y in the general formula (1) represents a bivalent group represented by chemical formula (Y1), chemical formula (Y2), or general formula (Y3):

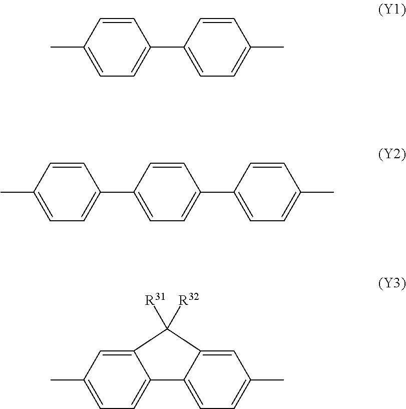

R³¹ and R³² in the general formula (Y3) each represent, independently of one another, a hydrogen atom, an alkyl group having a carbon number of at least 1 and no greater than 8, or a phenyl group.

An electrophotographic photosensitive member according to an aspect of the present disclosure includes a conductive substrate and a photosensitive layer. The photosensitive layer contains at least a charge generating material, a hole transport material, and a binder resin. The hole transport material contains the above-described compound mixture.

A production method for a compound mixture according to the present disclosure is a method for producing the above-described compound mixture. The production method for a compound mixture according to an aspect of the present disclosure includes: subjecting a liquid containing a compound represented by general formula (A) and a compound represented by general formula (B) to first stirring; and subjecting, to second stirring, the liquid to which a compound represented by general formula (C) has been further added. The second stirring is performed without purifying the liquid after the first stirring. A mixture of the compound represented by the general formula (1) and the compound represented by the general formula (2) can be obtained through the first stirring and the second stirring.

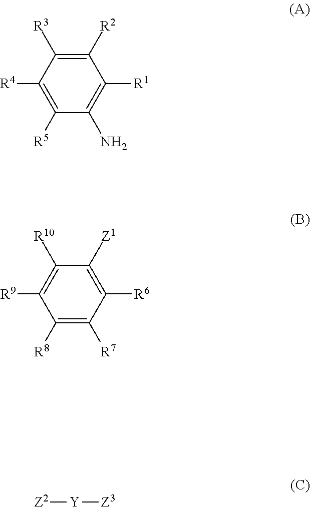

R¹, R², R³, R⁴, and R⁵ in the general formula (A) respectively represent the same groups as R^{1A}, R^{2A}, R^{3A}, R^{4A}, and R^{5A} in the general formula (1). R⁶, R⁷, R⁸, R⁹, and R¹⁰ in the general formula (B) respectively represent the same groups as R^{6A}, R^{7A}R^{8A}, R^{9A}, and R^{10A} in the general formula (1). Z¹ in the general formula (B) represents a halogen atom. Y in the general formula (C) represents the same group as Y in the general formula (1). Z² and Z³ in the general formula (C) each represent a halogen atom.

### BRIEF DESCRIPTION OF THE DRAWINGS

FIG. 1 is a partial cross-sectional view illustrating an example of an electrophotographic photosensitive member according to a third embodiment of the present disclosure.

FIG. 2 is a partial cross-sectional view illustrating another example of the electrophotographic photosensitive member according to the third embodiment of the present disclosure.

FIG. 3 is a partial cross-sectional view illustrating another example of the electrophotographic photosensitive member according to the third embodiment of the present disclosure.

FIG. 4 is a partial cross-sectional view illustrating another example of the electrophotographic photosensitive member according to the third embodiment of the present disclosure.

FIG. 5 is a partial cross-sectional view illustrating another example of the electrophotographic photosensitive member according to the third embodiment of the present disclosure.

FIG. 6 is a partial cross-sectional view illustrating another example of the electrophotographic photosensitive member according to the third embodiment of the present disclosure.

### DETAILED DESCRIPTION

Now, embodiments of the present disclosure will be described in detail. The present disclosure is, however, not limited to the following embodiments. The present disclosure can be appropriately altered within the scope of purpose of the present disclosure. In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof.

First, substituents used herein will be described. Examples of a halogen atom (halogen group) include a fluorine atom (fluoro group), a chlorine atom (chloro group), a bromine atom (bromo group), and iodine atom (iodo group).

Each of an alkyl group having a carbon number of at least 1 and no greater than 8, an alkyl group having a carbon number of at least 1 and no greater than 6, an alkyl group having a carbon number of at least 1 and no greater than 4, an alkyl group having a carbon number of at least 1 and no greater than 3, and an alkyl group having a carbon number of at least 2 and no greater than 4 is an unsubstituted straight chain or branched chain alkyl group. Examples of an alkyl group having a carbon number of at least 1 and no greater than 8 include a methyl group, an ethyl group, a n-propyl group, an isopropyl group, a n-butyl group, a sec-butyl group, a tert-butyl group, a n-pentyl group, an isopentyl group, a neopentyl group, a straight chain or branched chain hexyl group, a straight chain or branched chain heptyl group, and a straight chain or branched chain octyl group. Examples of an alkyl group having a carbon number of at least 1 and no greater than 6 include those having a carbon number of at least 1 and no greater than 6 among the groups described above as the examples of the alkyl group having a carbon number of at least 1 and no greater than 8. Examples of an alkyl group having a carbon number of at least 1 and no greater than 4 include those having a carbon number of at least 1 and no greater than 4 among the groups described above as the examples of the alkyl group having a carbon number of at least 1 and no greater than 8. Examples of an alkyl group having a carbon number of at least 1 and no greater than 3 include those having a carbon number of at least 1 and no greater than 3 among the groups described above as the examples of the alkyl group having a carbon number of at least 1 and no greater than 8. Examples of an alkyl group having a carbon number of at least 2 and no greater than 4 include those having a carbon number of at least 2 and no greater than 4 among the groups described above as the examples of the alkyl group having a carbon number of at least 1 and no greater than 8.

Each of an alkoxy group having a carbon number of at least 1 and no greater than 8, an alkoxy group having a carbon number of at least 1 and no greater than 6, and an alkoxy group having a carbon number of at least 1 and no greater than 3 is an unsubstituted straight chain or branched chain alkoxy group. Examples of an alkoxy group having a carbon number of at least 1 and no greater than 8 include a methoxy group, an ethoxy group, a n-propoxy group, an isopropoxy group, a n-butoxy group, a sec-butoxy group, a tert-butoxy group, a n-pentoxy group, an isopentoxy group, a neo-pentoxy group, a straight chain or branched chain hexyloxy group, a straight chain or branched chain heptyloxy group, and a straight chain or branched chain octyloxy group. Examples of an alkoxy group having a carbon number of at least 1 and no greater than 6 include those having a carbon number of at least 1 and no greater than 6 among the groups described above as the examples of the alkoxy group having a carbon number of at least 1 and no greater than 8. Examples of an alkoxy group having a carbon number of at least 1 and no greater than 3 include those having a carbon number of at least 1 and no greater than 3 among the groups described above as the examples of the alkoxy group having a carbon number of at least 1 and no greater than 8.

Each of an aryl group having a carbon number of at least 6 and no greater than 14 and an aryl group having a carbon number of at least 6 and no greater than 10 is an unsubstituted aryl group. Examples of an aryl group having a carbon number of at least 6 and no greater than 14 include a phenyl group, a naphthyl group, an indacenyl group, a biphenylenyl group, an acenaphthylenyl group, an anthryl group, and a phenanthryl group. Examples of an aryl group having a carbon number of at least 6 and no greater than 10 include a phenyl group and a naphthyl group.

A cycloalkyl group having a carbon number of at least 5 and no greater than 7 is an unsubstituted cycloalkyl group. Examples of a cycloalkyl group having a carbon number of at least 5 and no greater than 7 include a cyclopentyl group, a cyclohexyl group, and a cycloheptyl group. The substituents used herein have been described so far.

### First Embodiment: Compound Mixture

Next, a compound mixture according to a first embodiment of the present disclosure will be described. The compound mixture of the first embodiment contains a compound represented by general formula (1) and a compound represented by general formula (2). That is, the compound mixture according to the first embodiment includes a mixture of the compound represented by general formula (1) and the compound represented by general formula (2). Hereinafter, the compound represented by the general formula (1) is sometimes referred to as the compound (1), and the compound represented by the general formula (2) is sometimes referred to as the

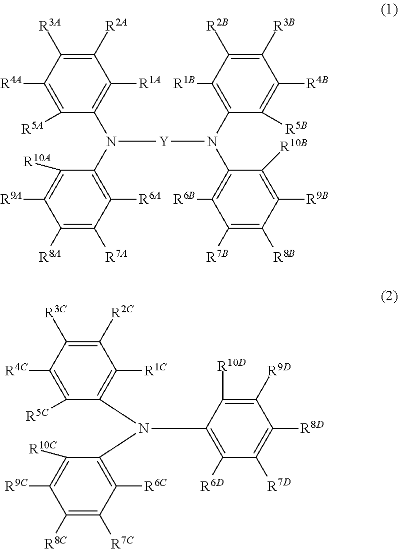

In the general formula (1), R^{1A}, R^{2A}, R^{3A}, R^{4A}, R^{5A}, R^{6A}, R^{7A}, R^{8A}, R^{9A}, and R^{10A} each represent, independently of one another, a hydrogen atom, an alkyl group having a carbon number of at least 1 and no greater than 8, an alkoxy group having a carbon number of at least 1 and no greater than 8, or an aryl group having a carbon number of at least 6 and no greater than 14. R^{1B} in the general formula (1) and R^{1C} in the general formula (2) represent the same group as R^{1A} in the general formula (1). R^{2B} in the general formula (1) and R^{2C} in the general formula (2) represent the same group as R^{2A} in the general formula (1). R^{3B} in the general formula (1) and R^{3C} in the general formula (2) represent the same group as R^{3A} in the general formula (1). R^{4B} in the general formula (1) and R^{4C} in the general formula (2) represent the same group as R^{4A} in the general formula (1). R^{5B} in the general formula (1) and R^{5C} in the general formula (2) represent the same group as R^{5A} in the general formula (1). R^{6B} in the general formula (1) and R^{6C} and R^{6D} in the general formula (2) represent the same group as R^{6A} in the general formula (1). R^{7B} in the general formula (1) and R^{7C} and R^{7D} in the general formula (2) represent the same group as R^{7A} in the general formula (1). R^{8B} in the general formula (1) and R^{8C} and R^{8D} in the general formula (2) represent the same group as R^{8A} in the general formula (1). R^{9B} in the general formula (1) and R^{9C} and R^{9D} in the general formula (2) represent the same group as R^{9A} in the general formula (1). R^{10B} in the general formula (1) and R^{10C} and R^{10D} in the general formula (2) represent the same group as R^{10A} in the general formula (1). Y in the general formula (1) represents a bivalent group represented by chemical formula (Y1), chemical formula (Y2), or general formula (Y3):

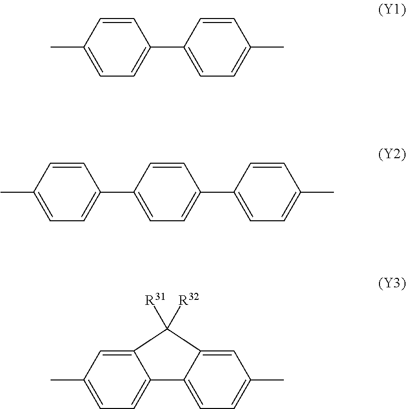

R³¹ and R³² in the general formula (Y3) each represent, independently of one another, a hydrogen atom, an alkyl group having a carbon number of at least 1 and no greater than 8, or a phenyl group.

The compound mixture of the first embodiment can improve crack resistance and sensitivity characteristics of an electrophotographic photosensitive member (hereinafter sometimes simply referred to as the photosensitive member) when contained in a photosensitive layer. Specifically, when the compound mixture contains the compound (1), the sensitivity characteristics of the photosensitive member can be improved. When the compound mixture contains the compound (2), the crack resistance of the photosensitive member can be improved. The compound (2) is a by-product generated in synthesizing the compound (1) that is the end product. Usually, an end product is obtained by removing a by-product through purification. The present inventors have found, however, that not only the sensitivity characteristics of the photosensitive member but also the crack resistance of the photosensitive member can be improved by deliberately allowing the compound (2) to be mixed with the compound (1) without completely removing the by-product of the compound (2) through purification.

The alkyl group having a carbon number of at least 1 and no greater than 8 that may be represented by R^{1A}, R^{2A}, R^{3A}, R^{4A}, R^{5A}, R^{6A}, R^{7A}, R^{8A}, R^{9A}, and R^{1A} in the general formula (2) is preferably an alkyl group having a carbon number of at least 1 and no greater than 6, more preferably an alkyl group having a carbon number of at least 1 and no greater than 3, and further preferably a methyl group or an ethyl group.

The alkoxy group having a carbon number of at least 1 and no greater than 8 that may be represented by R^{1A}, R^{2A}, R^{3A}, R^{4A}, R^{5A}, R^{6A}, R^{7A}, R^{8A}, R^{9A}, and R^{10A} in the general formula (1) is preferably an alkoxy group having a carbon number of at least 1 and no greater than 6, more preferably an alkoxy group having a carbon number of at least 1 and no greater than 3, and further preferably a methoxy group.

The aryl group having a carbon number of at least 6 and no greater than 14 that may be represented by R^{1A}, R^{2A}, R^{3A}, R^{4A}, R^{5A}, R^{6A}, R^{7A}, R^{8A}, R^{9A}, and R^{1A} in the general formula (1) is preferably an aryl group having a carbon number of at least 6 and no greater than 10.

The alkyl group having a carbon number of at least 1 and no greater than 8 that may be represented by R³¹ and R³² in the general formula (Y3) is preferably an alkyl group having a carbon number of at least 1 and no greater than 6, more preferably an alkyl group having a carbon number of at least 1 and no greater than 3, and further preferably a methyl group.

In order to further improve the sensitivity characteristics with the crack resistance improved, Y in the general formula (1) preferably represents a bivalent group represented by the chemical formula (Y2).

In order to further improve the sensitivity characteristics with the crack resistance improved, at least two of R^{1A}, R^{2A}, R^{3A}, R^{4A}, R^{5A}, R^{6A}, R^{7A}, R^{8A}, R^{9A}, and R^{10A} in the general formula (1) preferably represent a group different from a hydrogen atom, and the others of R^{1A}, R^{2A}, R^{3A}, R^{4A}, R^{5A}, R^{6A}, R^{7A}, R^{8A}, R^{9A}, and R^{10A} preferably represent a hydrogen atom. Besides, a sum of the carbon numbers of groups different from a hydrogen atom is preferably at least 3. It is noted that the group different from a hydrogen atom represented by R^{1A}, R^{2A}, R^{3A}, R^{4A}, R^{5A}, R^{6A}, R^{7A}, R^{8A}, R^{9A}, and R^{1A} in the general formula (1) is an alkyl group having a carbon number of at least 1 and no greater than 8, an alkoxy group having a carbon number of at least 1 and no greater than 8, or an aryl group having a carbon number of at least 6 and no greater than 14.

In order to further improve the sensitivity characteristics with the crack resistance improved, R^{3A} in the general formula (1) preferably represents an alkoxy group having a carbon number of at least 1 and no greater than 8.

In order to further improve the sensitivity characteristics with the crack resistance improved, it is preferable that one or two of R^{1A}, R^{3A} and R^{5A} in the general formula (1) represent an alkyl group having a carbon number of at least 1 and no greater than 8 or an alkoxy group having a carbon number of at least 1 and no greater than 8, that the other(s) of R^{1A}, R^{3A} and R^{5A} represent a hydrogen atom, and that R^{2A} and R^{4A} each represent a hydrogen atom.

In order to further improve the sensitivity characteristics with the crack resistance improved, it is preferable that R^{8A} in the general formula (1) represents a hydrogen atom or an alkyl group having a carbon number of at least 1 and no greater than 8, and that R^{6A}, R^{7A}, R^{9A}, and R^{10A} each represent a hydrogen atom.

Now, a case where Y represents a bivalent group represented by the chemical formula (Y2) will be described. In order to improve the crack resistance and the sensitivity characteristics, it is preferable that the compound (1) is a compound represented by chemical formula (HTM-1) and that the compound (2) is a compound represented by chemical formula (HTM-A). In order to improve the crack resistance and the sensitivity characteristics, it is preferable that the compound (1) is a compound represented by chemical formula (HTM-2) and that the compound (2) is a compound represented by chemical formula (HTM-B). In order to improve the crack resistance and the sensitivity characteristics, it is preferable that the compound (1) is a compound represented by chemical formula (HTM-3) and that the compound (2) is a compound represented by chemical formula (HTM-C). In order to improve the crack resistance and the sensitivity characteristics, it is preferable that the compound (1) is a compound represented by chemical formula (HTM-4) and that the compound (2) is a compound represented by chemical formula (HTM-D). Hereinafter, the compounds respectively represented by the chemical formulas (HTM-1) to (HTM-4) are sometimes referred to respectively as compounds (HTM-1) to (HTM-4). Besides, the compounds respectively represented by the chemical formulas (HTM-A) to (HTM-D) are sometimes referred to respectively as compounds (HTM-A) to (HTM-D).

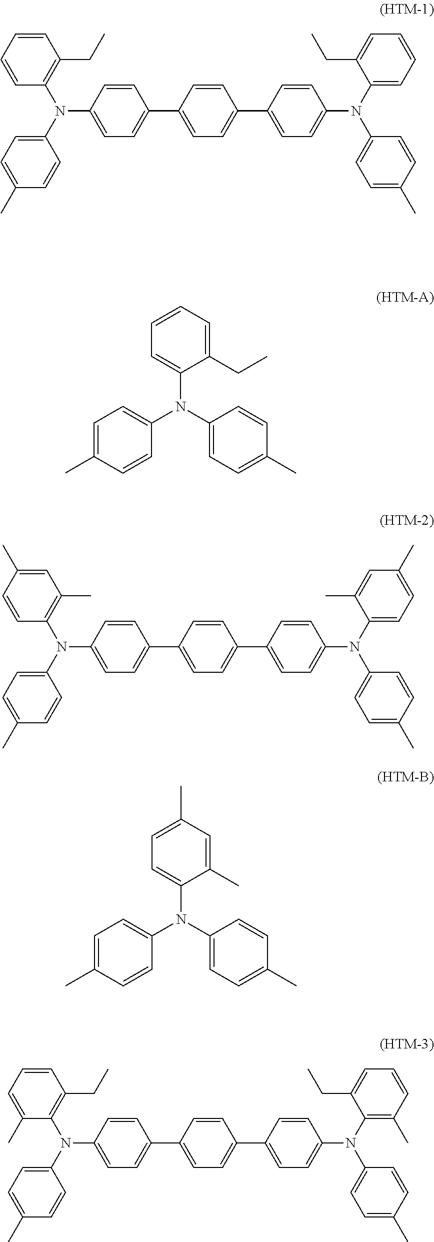

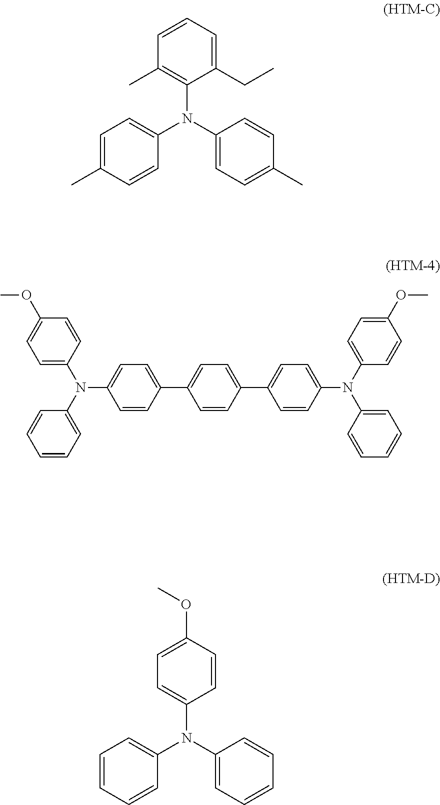

Now, a case where Y in the general formula (1) represents a bivalent group represented by the chemical formula (Y1) will be further described. In order to improve the crack resistance and the sensitivity characteristics, it is preferable that the compound (1) is a compound represented by chemical formula (HTM-5) and that the compound (2) is a compound represented by chemical formula (HTM-E). Hereinafter, the compounds respectively represented by the chemical formulas (HTM-5) and (HTM-E) are sometimes referred to respectively as compounds (HTM-5) and (HTM-E).

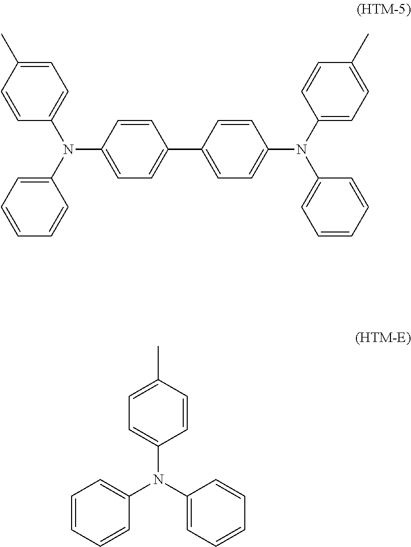 [SMILES: Cc1ccc(N(c2ccccc2)c2ccc(-c3ccc(N(c4ccccc4)c4ccc(C)cc4)cc3)cc2)cc1 ; Cc1ccc(N(c2ccccc2)c2ccccc2)cc1]

Now, a case where Y in the general formula (1) represents a bivalent group represented by the chemical formula (Y3) will be further described. In order to improve the crack resistance and the sensitivity characteristics, it is preferable that the compound (1) is a compound represented by chemical formula (HTM-6) and that the compound (2) is a compound represented by chemical formula (HTM-F). Hereinafter, the compounds respectively represented by the chemical formulas (HTM-6) and (HTM-F) are sometimes referred to respectively as compounds (HTM-6) and (HTM-F).

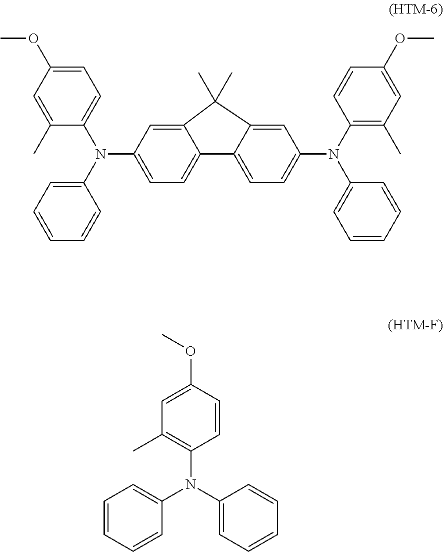

A content ratio of the compound (2) with respect to a total mass of the compound (1) and the compound (2) is preferably at least 1.0% by mass and no greater than 30.0% by mass, and more preferably at least 1.0% by mass and no greater than 10.0% by mass. When the content ratio of the compound (1) with respect to the total mass of the compound (1) and the compound (2) is at least 10% by mass, the crack resistance of the photosensitive member can be further improved. When the content ratio of the compound (2) with respect to the total mass of the compound (1) and the compound (2) is no greater than 10.0% by mass, the sensitivity characteristics of the photosensitive member can be further improved. A method for adjusting the content ratio of the compound (2) with respect to the total mass of the compound (1) and the compound (2) will be described later in a second embodiment.

Suitable examples of the compound mixture include compound mixtures (F-1) to (F-10) shown in Table 1 below. “Content Ratio of Compound (2)” shown in Table 1 indicates the content ratio (unit: % by mass) of the compound (2) with respect to the total mass of the compound (1) and the compound (2).

TABLE 1

| | Compound | Compound | Content Ratio of Compound (2) |
|---|---|---|---|
| Compound Mixture | (1) | (2) | (% by mass) |
| F-1 | HTM-1 | HTM-A | at least 2.0 and no greater than 5.0 |
| F-2 | HTM-2 | HTM-B | at least 2.0 and no greater than 5.0 |
| F-3 | HTM-3 | HTM-C | at least 2.0 and no greater than 5.0 |
| F-4 | HTM-4 | HTM-D | at least 2.0 and no greater than 5.0 |
| F-5 | HTM-5 | HTM-E | at least 2.0 and no greater than 5.0 |
| F-6 | HTM-6 | HTM-F | at least 2.0 and no greater than 5.0 |
| F-7 | HTM-1 | HTM-A | at least 1.0 and less than 2.0 |
| F-8 | HTM-1 | HTM-A | over 5.0 and no greater than 10.0 |
| F-9 | HTM-1 | HTM-A | over 10.0 and no greater than 20.0 |
| F-10 | HTM-1 | HTM-A | over 20.0 and no greater than 30.0 |

The compound mixture may contain merely one compound (1) and merely one compound (2). Alternatively, the compound mixture may contain two or more compounds (1) and two or more compounds (2).

### Second Embodiment: Production Method for Compound Mixture

Next, a production method for a compound mixture according to a second embodiment of the present disclosure will be described. The production method for a compound mixture according to the second embodiment is an example of a method for producing the compound mixture according to the first embodiment. A compound mixture produced by the production method of the second embodiment can improve the crack resistance and the sensitivity characteristics of a photosensitive member.

The production method for a compound mixture of the second embodiment includes, for example, a first stirring step and a second stirring step. In the first stirring step, a liquid is subjected to first stirring. The liquid contains a compound represented by general formula (A) and a compound represented by general formula (B). In the second stirring step, a compound represented by general formula (C) is further added to the liquid resulting from the first stirring step, and the resultant is subjected to second stirring. The second stirring step is performed without purifying the liquid after the first stirring step. Through the first stirring step and the second stirring step, a mixture of a compound (1) and a compound (2) is obtained. The thus obtained mixture of the compound (1) and the compound (2) corresponds to the compound mixture according to the first embodiment. Hereinafter, the compounds respectively represented by the general formulas (A), (B), and (C) are sometimes referred to respectively as the compounds (A), (B), and (C).

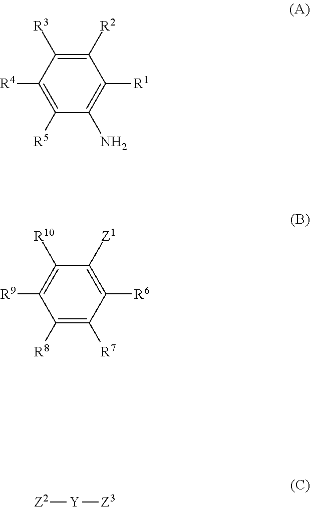

R¹, R², R³, R⁴, and R⁵ in the general formula (A) respectively represent the same groups as R^{1A}, R^{2A}, R^{3A}, R^{4A}, and R^{5A} in the general formula (1). R⁶, R⁷, R⁸, R⁹, and R¹⁰ in the general formula (B) respectively represent the same groups as R^{6A}, R^{7A}R^{8A}, R^{9A}, and R^{10A} in the general formula (1). Z¹ in the general formula (B) represents a halogen atom. Y in the general formula (C) represents the same group as Y in the general formula (1). Z² and Z³ in the general formula (C) each represent a halogen atom.

As represented by the following reaction formula (r-1), through a reaction between 1 molar equivalent of the compound (A) and 2 molar equivalents of the compound (B), 1 molar equivalent of the compound (2) is obtained. In the first stirring step, the reaction represented by the reaction formula (r-1) proceeds. It is noted that the reaction represented by the reaction formula (r-1) may proceed not only in the first stirring step but also in the second stirring step.

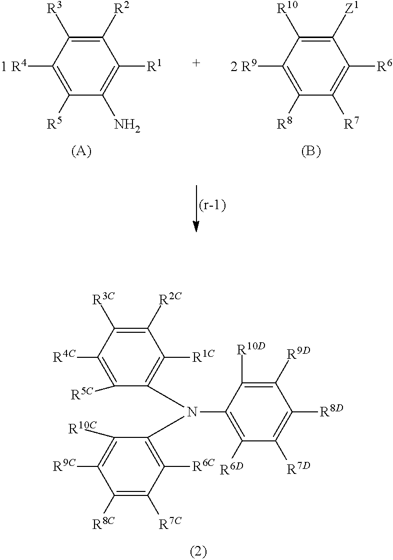

Besides, as represented by the following reaction formulas (r-2) and (r-3), through a reaction between 2 molar equivalents of the compound (A), 2 molar equivalents of the compound (B), and 1 molar equivalent of the compound (C), 1 molar equivalent of the compound (1) is obtained. More specifically, as represented by the reaction formula (r-2), through a reaction between 2 molar equivalents of the compound (A) and 2 molar equivalents of the compound (B), 2 molar equivalents of a compound represented by chemical formula (D) (hereinafter sometimes referred to as the compound (D)) is obtained. The compound (D) is an intermediate product. Subsequently, as represented by the reaction formula (r-3), through a reaction between 2 molar equivalents of the compound (D) and 1 molar equivalent of the compound (C), 1 molar equivalent of the compound (1) is obtained. In the first stirring step, the reaction represented by the reaction formula (r-2) proceeds, and in the second stirring step, the reaction represented by the reaction formula (r-3) proceeds. It is noted that the reaction represented by the reaction formula (r-2) may proceed not only in the first stirring step but also in the second stirring step.

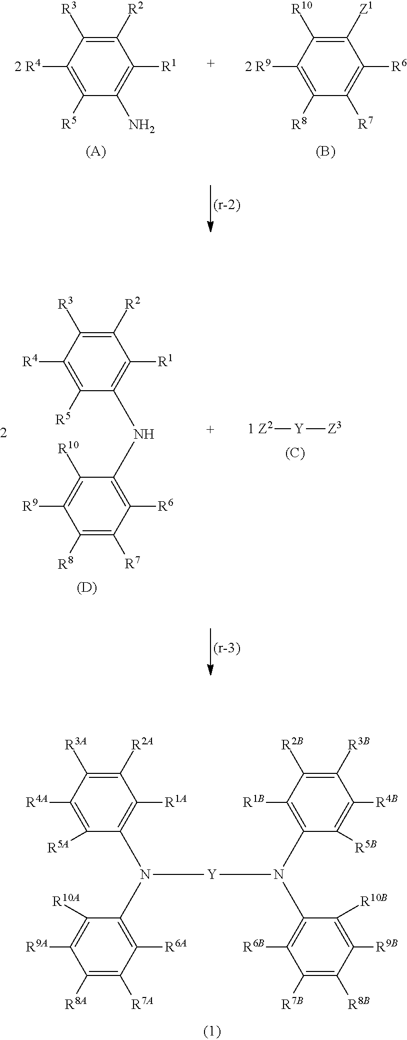

Since raw materials of the compounds (1) and (2) are common to those of the compounds (A) and (B), R¹ in the general formula (A) is the same group as R^{1A} and R^{1B} in the general formula (1) and R^{1C} in the general formula (2). Similarly to R¹, R² to R⁵ in the general formula (A) are the same groups as the corresponding substituents in the general formulas (1) and (2). Since raw materials of the compounds (1) and (2) are common to those of the compounds (A) and (B), R⁶ in the general formula (B) is the same group as R^{6A} and R^{1B} in the general formula (1) and R^{6C} and R^{6D} in the general formula (2). Similarly to R⁶, R⁷ to R¹⁰ in the general formula (B) are the same groups as the corresponding substituents in the general formulas (1) and (2).

A palladium catalyst may be added to the liquid to be subjected to the first stirring in the first stirring step and the liquid to be subjected to the second stirring in the second stirring step. Examples of the palladium catalyst include palladium (II) acetate, palladium (II) chloride, sodium hexachloropalladate (IV) tetrahydrate, and tris(dibenzylideneacetone)dipalladium (0).

A ligand may be added to the liquid to be subjected to the first stirring in the first stirring step and the liquid to be subjected to the second stirring in the second stirring step. Examples of the ligand include 2-dicyclohexylphosphino-2′,4′,6′-triisopropylbiphenyl, (4-dimethylaminophenyl)di-tert-butylphosphine, tricyclohexylphosphine, triphenylphosphine, and methyl diphenylphosphine.

A base may be added to the liquid to be subjected to the first stirring in the first stirring step and the liquid to be subjected to the second stirring in the second stirring step. Examples of the base include sodium tert-butoxide, tripotassium phosphate, and cesium fluoride.

A solvent may be added to the liquid to be subjected to the first stirring in the first stirring step and the liquid to be subjected to the second stirring in the second stirring step. Examples of the solvent include xylene, toluene, tetrahydrofuran, and dimethylformamide.

The temperature of the liquid to be subjected to the first stirring in the first stirring step and the liquid to be subjected to the second stirring in the second stirring step is preferably at least 80° C. and no greater than 140° C. The time of the first stirring is preferably at least 1 hour and no greater than 10 hours, and more preferably at least 5 hours and no greater than 10 hours. The time of the second stirring is preferably at least 1 hour and no greater than 10 hours, and more preferably at least 1 hour and no greater than 4 hours. The first stirring and the second stirring may be performed in an atmosphere of an inert gas (such as a nitrogen gas or an argon gas).

In the production method for a compound mixture of the second embodiment, the liquid is not purified after the first stirring step. Therefore, the production procedure can be simplified.

In the production method for a compound mixture of the second embodiment, the mixture of the compound (1) and the compound (2) is obtained through the first stirring step and the second stirring step. Since a product is obtained in the form of a mixture, there is no need to perform an operation for respectively weighing the compound (1) and the compound (2) and mixing the weighed compounds.

In the production method for a compound mixture of the second embodiment, the compound (2) remains in the compound mixture resulting from the second stirring step. Since the compound (2) is deliberately allowed to remain without completely removing the compound (2) corresponding to a by-product, when the resultant compound mixture is contained in a photosensitive layer, not only the sensitivity characteristics of a photosensitive member but also the crack resistance of the photosensitive member can be improved. Incidentally, purification may be performed after the second stirring step so as not to completely remove the compound (2) from the compound mixture. Besides, purification may be performed after the second stirring step so as not to completely remove the compound (1) from the compound mixture. Examples of a purification method employed after the second stirring step include an activated clay treatment, recrystallization, and a combination of these.

A content ratio of the compound (2) with respect to a total mass of the compound (1) and the compound (2) can be adjusted by, for example, changing a ratio (B/A) of an addition amount of the compound (B) to an addition amount of the compound (A). The ratio (B/A) is a value in terms of molar ratio. As the ratio (B/A) is higher, the content ratio of the compound (2) with respect to the total mass of the compound (1) and the compound (2) is higher. The ratio (B/A) is preferably at least 1.05 and no greater than 1.45, and more preferably at least 1.05 and no greater than 1.25.

Alternatively, the content ratio of the compound (2) with respect to the total mass of the compound (1) and the compound (2) can be adjusted by, for example, changing a ratio (A/C) of the addition amount of the compound (A) to an addition amount of the compound (C). The ratio (A/C) is a value in terms of molar ratio. As the ratio (A/C) is higher, the content ratio of the compound (2) with respect to the total mass of the compound (1) and the compound (2) is higher. The ratio (A/C) is preferably at least 2.30 and no greater than 3.30, and more preferably at least 2.30 and no greater than 2.60.

Alternatively, the content ratio of the compound (2) with respect to the total mass of the compound (1) and the compound (2) can be adjusted, for example, by performing the purification after the second stirring step without completely removing the compound (2) and changing conditions for the purification. Incidentally, in order to adjust the content ratio of the compound (2) with respect to the total mass of the compound (1) and the compound (2), either of or both of the compound (1) and the compound (2) may be further added to the mixture obtained through the first stirring step and the second stirring step.

### Third Embodiment: Photosensitive Member

Next, a photosensitive member according to a third embodiment of the present disclosure will be described. The photosensitive member of the third embodiment includes a conductive substrate and a photosensitive layer. The photosensitive layer contains at least a charge generating material, a hole transport material, and a binder resin. The hole transport material contains the compound mixture of the first embodiment. Since the compound mixture of the first embodiment is contained as the hole transport material in the photosensitive layer, the crack resistance and the sensitivity characteristics of the photosensitive member can be improved.

The photosensitive member may be a multi-layer electrophotographic photosensitive member (hereinafter sometimes referred to as the multi-layer photosensitive member), or may be a single-layer electrophotographic photosensitive member (hereinafter sometimes referred to as the single-layer photosensitive member).

(Multi-Layer Photosensitive Member)

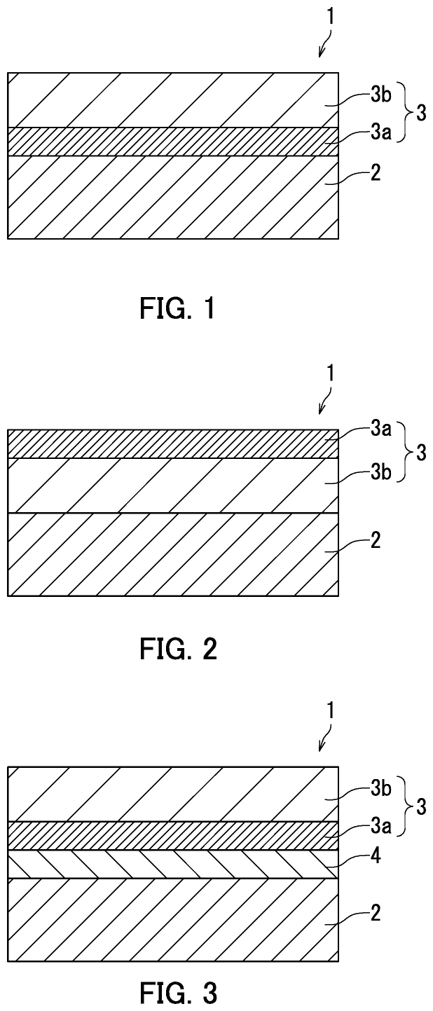

Now, a case where the photosensitive member 1 is a multi-layer photosensitive member will be described with reference to FIGS. 1 to 3. FIGS. 1 to 3 are partial cross-sectional views each illustrating an example of the photosensitive member 1 (more specifically, the multi-layer photosensitive member).

As illustrated in FIG. 1, the multi-layer photosensitive member shown as an example of the photosensitive member 1 includes, for example, a conductive substrate 2 and a photosensitive layer 3. The photosensitive layer 3 includes a charge generation layer 3a and a charge transport layer 3b. In other words, the multi-layer photosensitive member includes, as the photosensitive layer 3, the charge generation layer 3a and the charge transport layer 3b.

In order to improve abrasion resistance of the multi-layer photosensitive member, the charge generation layer 3a is preferably provided on the conductive substrate 2 as illustrated in FIG. 1. In order to improve abrasion resistance of the multi-layer photosensitive member, the charge transport layer 3b is preferably provided on the charge generation layer 3a. In the multi-layer photosensitive member, however, the charge transport layer 3b may be provided on the conductive substrate 2 as illustrated in FIG. 2. Alternatively, the charge generation layer 3a may be provided on the charge transport layer 3b.

As illustrated in FIGS. 1 and 2, the photosensitive layer 3 may be provided directly on the conductive substrate 2. Alternatively, the photosensitive layer 3 may be provided above the conductive substrate 2 with an intermediate layer 4 therebetween as illustrated in FIG. 3.

As illustrated in FIGS. 1 to 3, the photosensitive layer 3 (specifically, for example, the charge transport layer 3b) may be provided as an outermost layer. Alternatively, a protection layer 5 (see FIG. 6) may be provided on the photosensitive layer 3.

The thickness of the charge generation layer 3a is not especially limited, and is preferably at least 0.01 m and no greater than 5 m, and more preferably at least 0.1 m and no greater than 3 μm. The charge generation layer 3a contains the charge generating material. The charge generation layer 3a may further contain a base resin if necessary. The charge generation layer 3a may further contain an additive if necessary.

The thickness of the charge transport layer 3b is not especially limited, and is preferably at least 2 m and no greater than 100 m, and more preferably at least 5 m and no greater than 50 μm. The charge transport layer 3b contains at least the hole transport material and the binder resin. The charge transport layer 3b may further contain an electron acceptor compound if necessary. The charge transport layer 3b may further contain an additive if necessary. The case where the photosensitive member 1 is a multi-layer photosensitive member has been described so far with reference to FIGS. 1 to 3.

(Single-Layer Photosensitive Member)

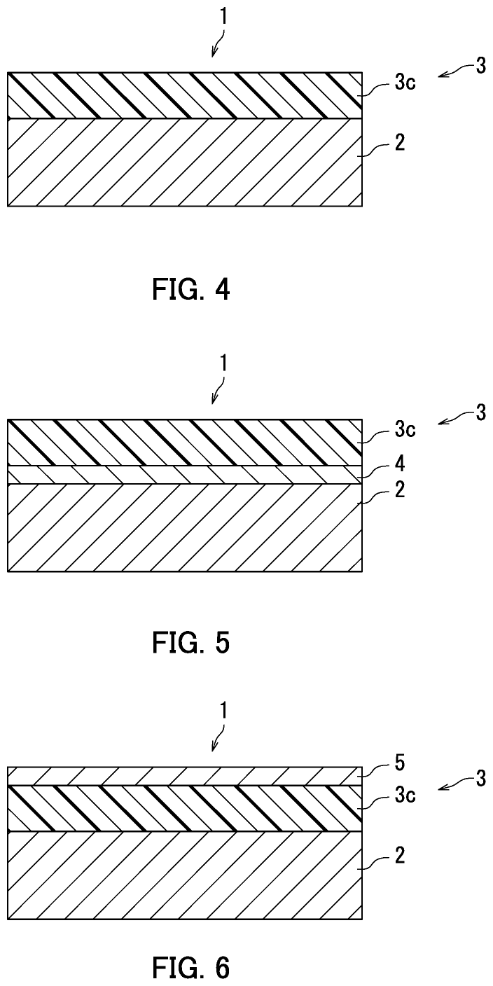

Now, a case where the photosensitive member 1 is a single-layer photosensitive member will be described with reference to FIGS. 4 to 6. FIGS. 4 to 6 are partial cross-sectional views each illustrating an example of the photosensitive member 1 (more specifically, the single-layer photosensitive member).

As illustrated in FIG. 4, the single-layer photosensitive member shown as an example of the photosensitive member 1 includes, for example, a conductive substrate 2 and a photosensitive layer 3. The photosensitive layer 3 is a single layer. Hereinafter, the photosensitive layer 3 of a single layer is sometimes referred to as a single-layer photosensitive layer 3c.

As illustrated in FIG. 4, the single-layer photosensitive layer 3 may be provided directly on the conductive substrate 2. Alternatively, the single-layer photosensitive layer 3C may be provided above the conductive substrate 2 with an intermediate layer 4 disposed therebetween as illustrated in FIG. 5.

As illustrated in FIGS. 4 and 5, the single-layer photosensitive layer 3C may be provided as an outermost layer. Alternatively, a protection layer 5 may be provided on the single-layer photosensitive layer 3C as illustrated in FIG. 6.

The thickness of the single-layer photosensitive layer 3C is not especially limited, and is preferably at least 5 μm and no greater than 100 μm, and more preferably at least 10 μm and no greater than 50 μm. The single-layer photosensitive layer 3C contains at least the charge generating material, the hole transport material, and the binder resin. The single-layer photosensitive layer 3C may further contain an electron transport material if necessary. The single-layer photosensitive layer 3C may further contain an additive if necessary. The case where the photosensitive member 1 is a single-layer photosensitive member has been described so far with reference to FIGS. 4 to 6.

Next, the charge generating material, the hole transport material, and the binder resin contained in the photosensitive layer will be described. Besides, the electron acceptor compound, the electron transport material, the base resin, and the additive contained in the photosensitive layer if necessary will also be described.

(Charge Generating Material)

Examples of the charge generating material include a phthalocyanine-based pigment, a perylene-based pigment, a bisazo pigment, a trisazo pigment, a dithioketopyrrolopyrrole pigment, a metal-free phthalocyanine pigment, a metal naphthalocyanine pigment, a squaraine pigment, an indigo pigment, an azulenium pigment, a cyanine pigment, a powder of an inorganic photoconductive material (such as selenium, selenium-tellurium, selenium-arsenic, cadmium sulfide, or amorphous silicon), a pyrylium pigment, an anthanthrone-based pigment, a triphenylmethane-based pigment, a threne-based pigment, a toluidine-based pigment, a pyrazoline-based pigment, and a quinacridone-based pigment. The charge generation layer or the single-layer photosensitive layer may contain merely one charge generating material, or may contain two or more charge generating materials.

Examples of the phthalocyanine-based pigment include metal-free phthalocyanine and metal phthalocyanine. Examples of the metal phthalocyanine include titanyl phthalocyanine, hydroxygallium phthalocyanine, and chlorogallium phthalocyanine. Metal-free phthalocyanine is represented by chemical formula (CGM-1). Titanyl phthalocyanine is represented by chemical formula (CGM-2).

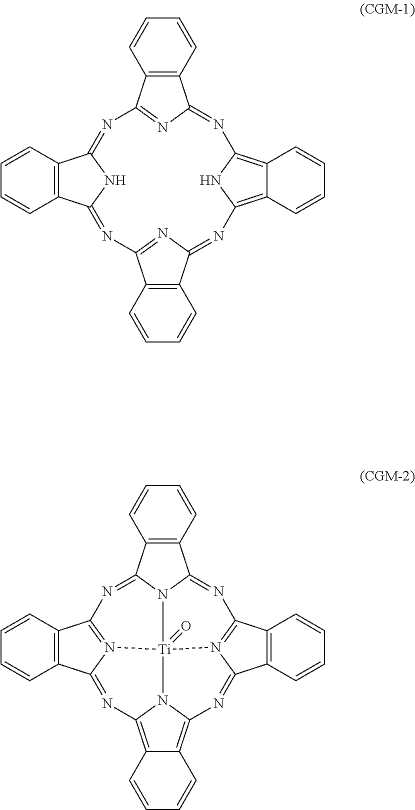

The phthalocyanine-based pigment may be crystalline or non-crystalline. An example of the crystal of metal-free phthalocyanine includes an X-form crystal of metal-free phthalocyanine (hereinafter sometimes referred to as the X-form metal-free phthalocyanine). Examples of the crystal of titanyl phthalocyanine include α-form, β-form, and Y-form crystals of titanyl phthalocyanine (hereinafter sometimes respectively referred to α-form, β-form, and Y-form titanyl phthalocyanine).

For example, in a digital optical image forming apparatus (such as a laser beam printer or a facsimile using a light source like a semiconductor laser), a photosensitive member having sensitivity in a wavelength range of 700 nm or higher is preferably used. The charge generating material is preferably a phthalocyanine-based pigment, more preferably metal-free phthalocyanine or titanyl phthalocyanine, further preferably X-form metal-free phthalocyanine or Y-form titanyl phthalocyanine, and particularly preferably Y-form titanyl phthalocyanine because such a pigment has high quantum yield in the wavelength range of 700 nm or higher.

In a photosensitive member applied to an image forming apparatus using a short-wavelength laser light source (such as a laser light source having a wavelength of at least 350 nm and no greater than 550 nm), an anthanthrone-based pigment is suitably used as the charge generating material.

When the photosensitive member is a multi-layer photosensitive member, a content of the charge generating material is preferably at least 10 parts by mass and no greater than 300 parts by mass relative to 100 parts by mass of the base resin, and more preferably at least 100 parts by mass and no greater than 200 parts by mass. When the photosensitive member is a single-layer photosensitive member, the content of the charge generating material is preferably at least 0.1 parts by mass and no greater than 50 parts by mass relative to 100 parts by mass of the binder resin, more preferably 0.5 parts by mass and no greater than 30 parts by mass, and particularly preferably at least 2 parts by mass and no greater than 3 parts by mass.

(Hole Transport Material)

The hole transport material contains the compound mixture according to the first embodiment. The photosensitive layer (for example, the charge transport layer or the single-layer photosensitive layer) contains, as the hole transport material, the compound mixture according to the first embodiment. The charge transport layer or the single-layer photosensitive layer may contain merely one compound mixture, or two or more compound mixtures.

The charge transport layer or the single-layer photosensitive layer may contain, as the hole transport material, merely the compound mixture according to the first embodiment. Alternatively, the charge transport layer or the single-layer photosensitive layer may further contain, in addition to the compound mixture according to the first embodiment, a hole transport material different from the compound mixture of the first embodiment (hereinafter sometimes referred to as a different hole transport material).

Examples of the different hole transport material include oxadiazole-based compounds (for example, 2,5-di(4-methylaminophenyl)-1,3,4-oxadiazole), styryl compounds (for example, 9-(4-diethylaminostyryl)anthracene), carbazole compounds (for example, polyvinyl carbazole), an organic polysilane compound, pyrazoline-based compounds (for example, 1-phenyl-3-(p-dimethylaminophenyl)pyrazoline), a hydrazone compound, an indole-based compound, an oxazole-based compound, an isoxazole-based compound, a thiazole-based compound, a thiadiazole-based compound, an imidazole-based compound, a pyrazole-based compound, and a triazole-based compound.

When the photosensitive member is a multi-layer photosensitive member, the content of the hole transport material is preferably at least 50 parts by mass and no greater than 200 parts by mass relative to 100 parts by mass of the binder resin, and more preferably at least 90 parts by mass and no greater than 110 parts by mass. When the photosensitive member is a single-layer photosensitive member, the content of the hole transport material is preferably at least 50 parts by mass and no greater than 200 parts by mass relative to 100 parts by mass of the binder resin, and more preferably at least 50 parts by mass and no greater than 70 parts by mass.

(Binder Resin)

Examples of the binder resin contained in the charge transport layer or the single-layer photosensitive layer include a thermoplastic resin, a thermosetting resin, and a photocurable resin. Examples of the thermoplastic resin include a polyarylate resin, a polycarbonate resin, a styrene-butadiene copolymer, a styrene-acrylonitrile copolymer, a styrene-maleic acid copolymer, an acrylic acid polymer, a styrene-acrylic acid copolymer, a polyethylene resin, an ethylene-vinyl acetate copolymer, a chlorinated polyethylene resin, a polyvinyl chloride resin, a polypropylene resin, an ionomer resin, a vinyl chloride-vinyl acetate copolymer, an alkyd resin, a polyamide resin, a urethane resin, a polysulfone resin, a diallyl phthalate resin, a ketone resin, a polyvinyl butyral resin, a polyester resin, a polyvinyl acetal resin, and a polyether resin. Examples of the thermosetting resin include a silicone resin, an epoxy resin, a phenol resin, a urea resin, and a melamine resin. Examples of the photocurable resin include an epoxy compound to which acrylic acid is added, and a urethane compound to which acrylic acid is added. The charge transport layer or the single-layer photosensitive layer may contain merely one binder resin, or may contain two or more binder resins.

The viscosity average molecular weight of the binder resin is preferably at least 10,000, more preferably at least 20,000, further preferably at least 30,000, and particularly preferably at least 40,000. When the viscosity average molecular weight of the binder resin is at least 10,000, abrasion resistance of the binder resin is improved, and hence abrasion of the charge transport layer or the single-layer photosensitive layer can be inhibited. By contrast, the viscosity average molecular weight of the binder resin is preferably no greater than 80,000, and more preferably no greater than 70,000. When the viscosity average molecular weight of the binder resin is no greater than 80,000, the binder resin is easily dissolved in a solvent used for forming the charge transport layer or a solvent used for forming the single-layer photosensitive layer, and hence the charge transport layer or the single-layer photosensitive layer can be easily formed.

The binder resin is preferably a polyarylate resin. A suitable example of the polyarylate resin includes a polyarylate resin including at least one repeating unit represented by general formula (10) and at least one repeating unit represented by general formula (11). Hereinafter, the polyarylate resin including at least one repeating unit represented by the general formula (10) and at least one repeating unit represented by the general formula (11) is sometimes referred to as the polyarylate resin (PA). Besides, the repeating units respectively represented by the general formulas (10) and (11) are sometimes referred to respectively as the repeating units (10) and (11).

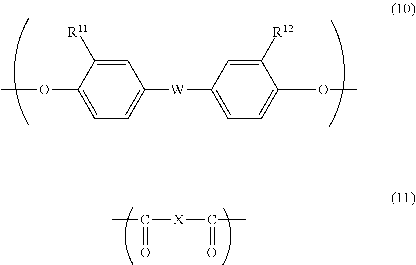

In the general formula (10), R¹¹ and R¹² each represent, independently of one another, a hydrogen atom or a methyl group. In the general formula (10), W represents a bivalent group represented by general formula (W1), general formula (W2), or chemical formula (W3).

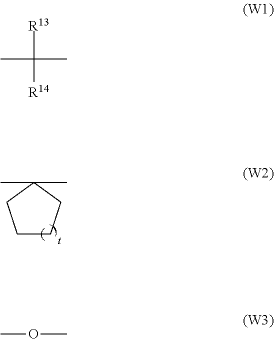

In the general formula (W1), R¹³ represents a hydrogen atom or an alkyl group having a carbon number of at least 1 and no greater than 4, and R¹⁴ represents an alkyl group having a carbon number of at least 1 and no greater than 4. In the general formula (W2), t represents an integer of at least 1 and no greater than 3.

In the general formula (11), X represents a bivalent group represented by chemical formula (X1), chemical formula (X2), or chemical formula (X3).

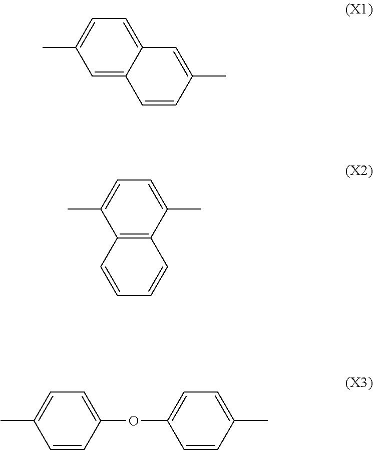

The alkyl group having a carbon number of at least 1 and no greater than 4 that may be represented by R¹³ in the general formula (W1) is preferably a methyl group. The alkyl group having a carbon number of at least 1 and no greater than 4 that may be represented by R¹⁴ in the general formula (W1) is preferably an alkyl group having a carbon number of at least 2 and no greater than 4, and more preferably an ethyl group. Besides, t in the general formula (W2) preferably represents 2.

Suitable examples of the repeating unit (10) include repeating units represented by chemical formulas (10-1), (10-2), and (10-3). Hereinafter the repeating units respectively represented by the chemical formulas (10-1), (10-2), and (10-3) are sometimes referred to respectively as the repeating units (10-1), (10-2), and (10-3).

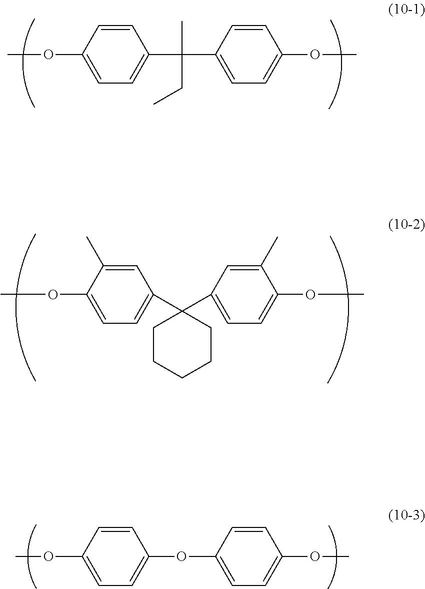

Suitable examples of the repeating unit (11) include repeating units represented by chemical formulas (11-X1), (11-X2), and (11-X3) (hereinafter sometimes referred to respectively as the repeating units (11-X1), (11-X2), and (11-X3).

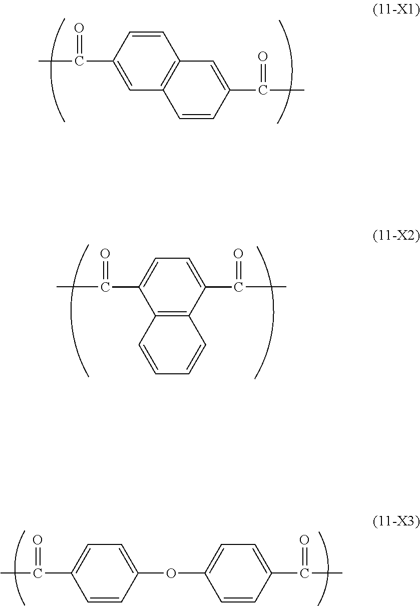

The polyarylate resin (PA) is preferably used in a first aspect or a second aspect described below. Now, polyarylate resins (PA) according to the first aspect and the second aspect will be described.

The first aspect of the polyarylate resin (PA) includes at least two repeating units (11). The polyarylate resin (PA) of the first aspect is preferably a polyarylate resin including at least one repeating unit (10) and at least two repeating units (11), and more preferably a polyarylate resin including one repeating unit (10) and two repeating units (11).

The at least two repeating units (11) included in the polyarylate resin (PA) of the first aspect preferably include the repeating units (11-X1) and (11-X2). Alternatively, the at least two repeating units (11) included in the polyarylate resin (PA) of the first aspect preferably include the repeating units (11-X1) and (11-X3).

When the at least two repeating units (11) included in the polyarylate resin (PA) of the first aspect include the repeating unit (11-X1) and another repeating unit (11) different from the repeating unit (11-X1), a ratio of the repeating number of the repeating unit (11-X1) to a total repeating number of the repeating units (11) (hereinafter sometimes referred to as the ratio p) is preferably at least 0.10 and no greater than 0.90, more preferably at least 0.20 and no greater than 0.80, further preferably at least 0.30 and no greater than 0.70, and further more preferably at least 0.40 and no greater than 0.60, and particularly preferably 0.50.

Suitable examples of the polyarylate resin (PA) of the first aspect include a first polyarylate resin, a second polyarylate resin, and a third polyarylate resin. The first polyarylate resin includes, as represented by the following chemical formulas, the repeating unit (10-1), the repeating unit (11-X1), and the repeating unit (11-X3).

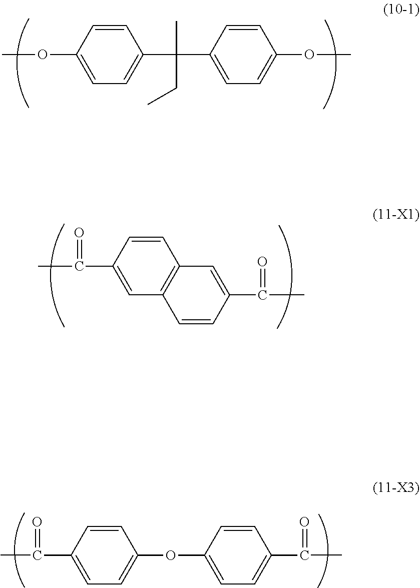

The second polyarylate resin includes, as represented by the following chemical formulas, the repeating unit (10-2), the repeating unit (11-X1), and the repeating unit (11-X3).

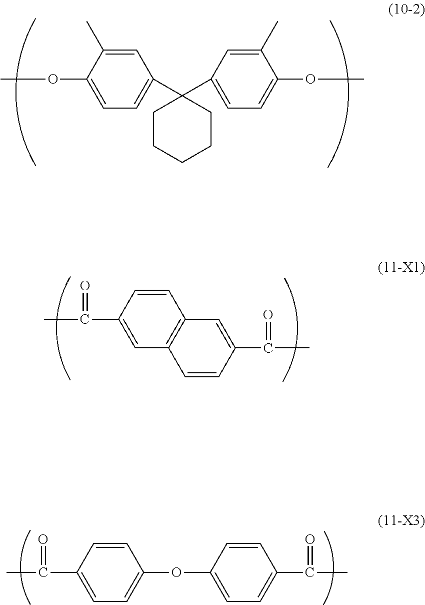

The third polyarylate resin includes, as represented by the following chemical formulas, the repeating unit (10-2), the repeating unit (11-X1), and the repeating unit (11-X2).

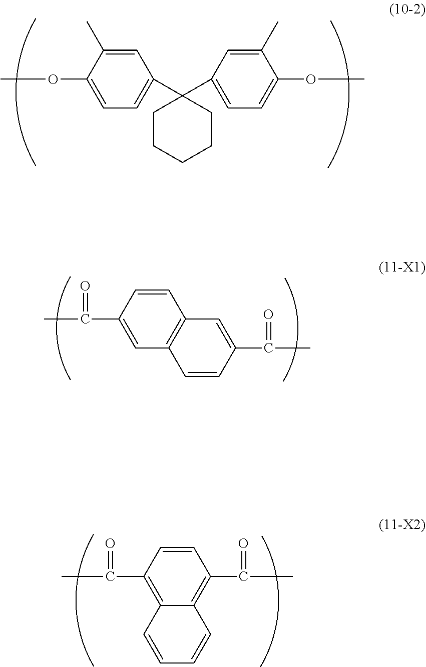

The polyarylate resin (PA) of the first aspect has been described so far. Next, the polyarylate resin (PA) of the second aspect will be described. The polyarylate resin (PA) of the second aspect includes at least two repeating units (10). The polyarylate resin (PA) of the second aspect is preferably a polyarylate resin including at least two repeating units (10) and at least one repeating unit (11), and more preferably a polyarylate resin including two repeating units (10) and one repeating unit (11).

The at least two repeating units (10) included in the polyarylate resin (PA) of the second aspect preferably include the repeating units (10-1) and (10-2). Alternatively, the at least two repeating units (10) included in the polyarylate resin (PA) of the second aspect preferably include the repeating units (10-1) and (10-3).

When the at least two repeating units (10) included in the polyarylate resin (PA) of the second aspect include the repeating unit (10-1) and another repeating unit (10) different from the repeating unit (10-1), a ratio of the repeat number of the repeating unit (10-1) to the total repeat number of the repeating units (10) (hereinafter sometimes referred to as the ratio q) is preferably at least 0.10 and less than 1.00, more preferably at least 0.50 and no greater than 0.95, further preferably at least 0.60 and no greater than 0.95, further more preferably at least 0.70 and no greater than 0.90, and particularly preferably 0.80.

It is noted that each of the ratios p and q is not a value obtained based on one molecular chain but is a value obtained based on the whole (a plurality of molecular chains) of the polyarylate resin (PA) contained in the charge transport layer or the single-layer photosensitive layer. The ratios p and q can be calculated based on a ¹H-NMR spectrum of the polyarylate resin (PA) measured using a proton nuclear magnetic resonance spectrometer.

A suitable example of the polyarylate resin (PA) of the second aspect is a fourth polyarylate resin. The fourth polyarylate resin includes, as represented by the following chemical formula, the repeating unit (10-1), the repeating unit (10-3), and the repeating unit (11-X3). When the fourth polyarylate resin is contained in the photosensitive layer, not only the crack resistance and the sensitivity characteristics of the photosensitive member but also the abrasion resistance of the photosensitive member can be particularly improved.

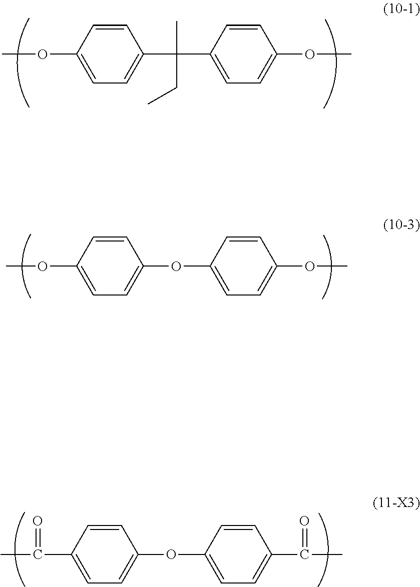

The polyarylate resin (PA) of the second aspect has been described so far. In the polyarylate resin (PA), the repeating unit (10) derived from aromatic diol and the repeating unit (11) derived from aromatic dicarboxylic acid are bonded to be adjacent to each other. When the polyarylate resin (PA) is a copolymer, the polyarylate resin (PA) may be any one of a random copolymer, an alternating copolymer, a periodic copolymer, and a block copolymer.

The polyarylate resin (PA) may include merely the repeating units (10) and (11) as the repeating units. Alternatively, the polyarylate resin (PA) may further include, in addition to the repeating units (10) and (11), a different repeating unit different from the repeating units (10) and (11).

The charge transport layer or the single-layer photosensitive layer may contain, as the binder resin, merely one polyarylate resin (PA), or may contain two or more polyarylate resins (PA). Besides, the charge transport layer or the single-layer photosensitive layer may contain, as the binder resin, the polyarylate resin (PA) alone, or may further contain another binder resin in addition to the polyarylate resin (PA).

A method for producing the polyarylate resin (PA) is not especially limited. An example of the method for producing the polyarylate resin (PA) includes a method in which an aromatic diol used for forming the repeating unit (10) and an aromatic dicarboxylic acid used for forming the repeating unit (11) are subjected to condensation polymerization. As a method for the condensation polymerization, any of known synthesis methods (specific examples include solution polymerization, melt polymerization, and interfacial polymerization) can be employed.

The aromatic diol used for forming the repeating unit (10) is a compound represented by general formula (BP-10) (hereinafter sometimes referred to as the compound (BP-10)). The aromatic dicarboxylic acid used for forming the repeating unit (11) is a compound represented by general formula (DC-11) (hereinafter sometimes referred to as the compound (DC-11)). It is noted that R¹¹, R¹², W, and X in the general formulas (BP-10) and (DC-11) respectively have the same meaning as R¹, R¹², W, and X in the general formulas (10) and (11).

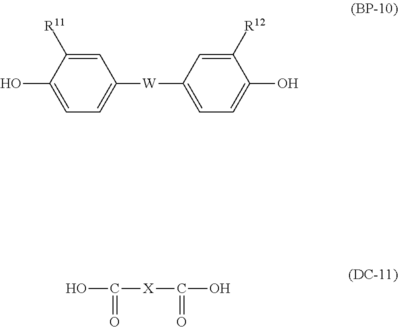

Suitable examples of the compound (BP-10) include compounds represented by chemical formulas (BP-10-1) to (BP-10-3) (hereinafter sometimes respectively referred to as compounds (BP-10-1) to (BP-10-3)).

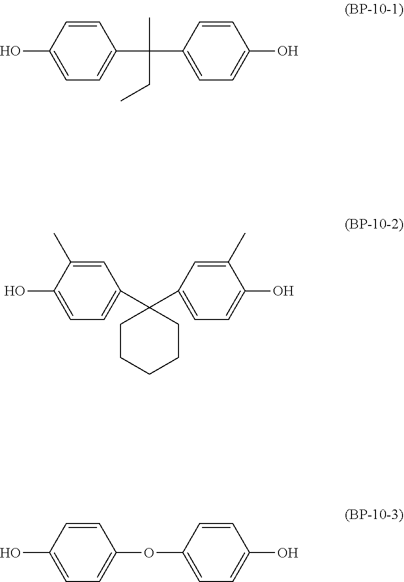 [SMILES: CCC(C)(c1ccc(O)cc1)c1ccc(O)cc1 ; Cc1cc(C2(c3ccc(O)c(C)c3)CCCCC2)ccc1O ; Oc1ccc(Oc2ccc(O)cc2)cc1]

Suitable examples of the compound (DC-11) include compounds represented by chemical formulas (DC-11-X1) to (DC-11-X3) (hereinafter sometimes respectively referred to as compounds (DC-11-X1) to (DC-11-X3)).

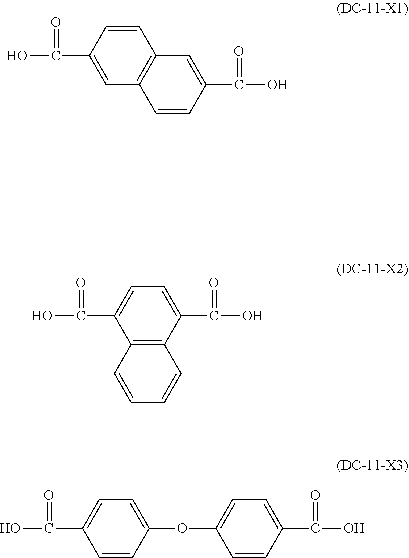 [SMILES: O=C(O)c1ccc2cc(C(=O)O)ccc2c1 ; O=C(O)c1ccc(C(=O)O)c2ccccc12 ; O=C(O)c1ccc(Oc2ccc(C(=O)O)cc2)cc1]

The aromatic diol (such as the compound (BP-10)) may be transformed to aromatic diacetate before use. The aromatic dicarboxylic acid (such as the compound (DC-11)) may be derivatized before use. Examples of a derivative of the aromatic dicarboxylic acid include aromatic dicarboxylic acid dichloride, aromatic dicarboxylic acid dimethyl ester, aromatic dicarboxylic acid diethyl ester, and aromatic dicarboxylic acid anhydride. The aromatic dicarboxylic acid dichloride is a compound in which two “—C(═O)—OH” groups of aromatic dicarboxylic acid are each substituted with a “—C(═O)—C1” group.

In the condensation polymerization of the aromatic diol and the aromatic dicarboxylic acid, either or both of a base and a catalyst may be added. The base and the catalyst can be appropriately selected from known bases and catalysts. An example of the base is sodium hydroxide. Examples of the catalyst include benzyl tributyl ammonium chloride, ammonium chloride, ammonium bromide, a quaternary ammonium salt, triethylamine, and trimethylamine. The suitable examples of the polyarylate resin have been described so far.

(Base Resin)

When the photosensitive member is a multi-layer photosensitive member, the charge generation layer may contain a base resin. Examples of the base resin are the same as the examples of the binder resin. The charge generation layer may contain merely one base resin, or may contain two or more base resins. In order to satisfactorily form the charge generation layer and the charge transport layer, the base resin contained in the charge generation layer is preferably different from the binder resin contained in the charge transport layer.

(Electron Acceptor Compound)

When the photosensitive member is a multi-layer photosensitive member, the charge transport layer preferably contains an electron acceptor compound. Examples of the electron acceptor compound include a quinone-based compound, a diimide-based compound, a hydrazone-based compound, a malononitrile-based compound, a thiopyran-based compound, a trinitrothioxanthone-based compound, a 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacridine, succinic anhydride, maleic anhydride, and dibromomaleic anhydride. Examples of the quinone-based compound include a diphenoquinone-based compound, an azoquinone-based compound, an anthraquinone-based compound, a naphthoquinone-based compound, a nitroanthraquinone-based compound, and a dinitroanthraquinone-based compound.

A suitable example of the electron acceptor compound is a compound represented by general formula (20) (hereinafter sometimes referred to as the compound (20)).

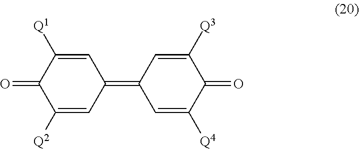

In the general formula (20), Q¹, Q², Q³, and Q⁴ each represent, independently of one another, an alkyl group having a carbon number of at least 1 and no greater than 6, an alkoxy group having a carbon number of at least 1 and no greater than 6, a cycloalkyl group having a carbon number of at least 5 and no greater than 7, or an aryl group having a carbon number of at least 6 and no greater than 14.

The alkyl group having a carbon number of at least 1 and no greater than 6 that may be represented by Q¹, Q², Q³, and Q⁴ in the general formula (20) is preferably a methyl group, an ethyl group, a butyl group, or a hexyl group, and is more preferably a tert-butyl group.

The alkoxy group having a carbon number of at least 1 and no greater than 6 that may be represented by Q¹, Q², Q³, and Q⁴ in the general formula (20) is preferably an alkoxy group having a carbon number of at least 1 and no greater than 3. The cycloalkyl group having a carbon number of at least 5 and no greater than 7 that may be represented by Q¹, Q², Q³, and Q⁴ in the general formula (20) is preferably a cyclohexyl group. The aryl group having a carbon number of at least 6 and no greater than 14 that may be represented by Q¹, Q², Q³, and Q⁴ in the general formula (20) is preferably an aryl group having a carbon number of at least 6 and no greater than 10, and is more preferably a phenyl group.

In the general formula (20), preferably, Q¹, Q², Q³, and Q⁴ each represent, independently of one another, an alkyl group having a carbon number of at least 1 and no greater than 6.

The electron acceptor compound is preferably a compound represented by chemical formula (E-1) (hereinafter referred to as the compound (E-1)). The compound (E-1) is a suitable example of the compound (20).

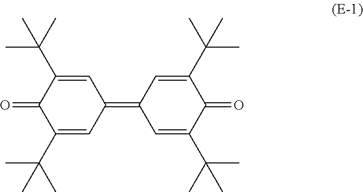 [SMILES: CC(C)(C)C1=CC(=C2C=C(C(C)(C)C)C(=O)C(C(C)(C)C)=C2)C=C(C(C)(C)C)C1=O]

The charge transport layer may contain, as the electron acceptor compound, merely one compound (20), or two or more compounds (20). The charge transport layer may further contain, in addition to the compound (20), an electron acceptor compound different from the compound (20).

The charge transport layer may contain merely one electron acceptor compound, or may contain two or more electron acceptor compounds. The content of the electron acceptor compound is preferably at least 0.1 parts by mass and no greater than 10 parts by mass relative to 100 parts by mass of the binder resin, and more preferably at least 1 part by mass and no greater than 5 parts by mass.

(Electron Transport Material)

When the photosensitive member is a single-layer photosensitive member, the single-layer photosensitive layer preferably contains an electron transport material. As the electron transport material contained in the single-layer photosensitive layer, any of known electron transport materials can be appropriately used.

(Additive)

Examples of the additive include a deterioration inhibitor (such as an antioxidant, a radical scavenger, a singlet quencher, or a UV absorber), a softener, a surface modifier, a bulking agent, a thickener, a dispersion stabilizer, a wax, a donor, a surfactant, a plasticizer, a sensitizer, and a leveling agent. Examples of the antioxidant includes hindered phenols (for example, di(tert-butyl)p-cresol). An example of the leveling agent is dimethyl silicone oil.

(Combination of Materials)

In order to improve the crack resistance and the sensitivity characteristics of the photosensitive member, the following combinations of the materials are preferred. Specifically, a combination of the hole transport material and the binder resin contained in the photosensitive layer is preferably any one of combination examples (G-1) to (G-13) shown in Table 2. It is more preferable that the combination of the hole transport material and the binder resin contained in the photosensitive layer is any one of the combination examples (G-1) to (G-13) shown in Table 2 and that the charge generating material is Y-form titanyl phthalocyanine. It is noted that “Content Ratio of Compound (2)” shown in Table 2 indicates a content ratio (unit: % by mass) of the compound (2) with respect to the total mass of the compound (1) and the compound (2). In Table 2, “HTM” refers to the hole transport material, and “Resin” refers to the binder resin.

TABLE 2

| | HTM | | | |
|---|---|---|---|---|
| | Compound Mixture | | | |
| Combination | Compound | Compound | Content Ratio of Compound (2) | |
| Example | (1) | (2) | [% by mass] | Resin |
| G-1 | HTM-1 | HTM-A | at least 2.0 and no greater than 5.0 | R-1 |
| G-2 | HTM-2 | HTM-B | at least 2.0 and no greater than 5.0 | R-1 |
| G-3 | HTM-3 | HTM-C | at least 2.0 and no greater than 5.0 | R-1 |
| G-4 | HTM-4 | HTM-D | at least 2.0 and no greater than 5.0 | R-1 |
| G-5 | HTM-5 | HTM-E | at least 2.0 and no greater than 5.0 | R-1 |
| G-6 | HTM-6 | HTM-F | at least 2.0 and no greater than 5.0 | R-1 |
| G-7 | HTM-1 | HTM-A | at least 2.0 and no greater than 5.0 | R-2 |
| G-8 | HTM-1 | HTM-A | at least 2.0 and no greater than 5.0 | R-3 |
| G-9 | HTM-1 | HTM-A | at least 2.0 and no greater than 5.0 | R-4 |
| G-10 | HTM-1 | HTM-A | at least 1.0 and less than 2.0 | R-1 |
| G-11 | HTM-1 | HTM-A | over 5.0 and no greater than 10.0 | R-1 |
| G-12 | HTM-1 | HTM-A | over 10.0 and no greater than 20.0 | R-1 |
| G-13 | HTM-1 | HTM-A | over 20.0 and no greater than 30.0 | R-1 |

When the photosensitive member is a multi-layer photosensitive member, in order to improve the crack resistance and the sensitivity characteristics of the multi-layer photosensitive member, the following combinations of materials are preferred. Specifically, a combination of the hole transport material and the binder resin contained in the charge transport layer is preferably any one of the combination examples (G-1) to (G-13) shown in Table 2. It is more preferable that the combination of the hole transport material and the binder resin contained in the charge transport layer is any one of the combination examples (G-1) to (G-13) shown in Table 2 and that the electron acceptor compound is the compound (E-1). It is further preferable that the combination of the hole transport material and the binder resin contained in the charge transport layer is any one of the combination examples (G-1) to (G-13) shown in Table 2, that the electron acceptor compound is the compound (E-1), and that the charge generating material contained in the charge generation layer is Y-form titanyl phthalocyanine. It is particularly preferable that the combination of the hole transport material and the binder resin contained in the charge transport layer is any one of the combination examples (G-1) to (G-13) shown in Table 2, that the electron acceptor compound is the compound (E-1), that the charge generating material contained in the charge generation layer is Y-form titanyl phthalocyanine, and that the additive contained in the charge transport layer is either or both of a hindered phenol antioxidant and a dimethyl silicone oil.

(Conductive Substrate)

The conductive substrate may be any substrate as long as at least a surface portion thereof is made from a conductive material. An example of the conductive substrate is a conductive substrate made from a conductive material. Another example of the conductive substrate is a conductive substrate coated with a conductive material. Examples of the conductive material include aluminum, iron, copper, tin, platinum, silver, vanadium, molybdenum, chromium, cadmium, titanium, nickel, palladium, indium, stainless steel, and brass. One of these conductive materials may be used independently, or a combination (for example, an alloy) of two or more of these may be used. Among these conductive materials, aluminum and an aluminum alloy are preferred because charge is satisfactorily transferred from the photosensitive layer to the conductive substrate in using these.

The shape of the conductive substrate is appropriately selected in accordance with a structure of an image forming apparatus. The conductive substrate can be in the shape of, for example, a sheet or a drum. Besides, the thickness of the conductive substrate is appropriately selected in accordance with the shape of the conductive substrate.

(Intermediate Layer)

The photosensitive member may include an intermediate layer (undercoating layer) if necessary. The intermediate layer contains, for example, inorganic particles and a resin used in the intermediate layer (intermediate layer resin). When the intermediate layer is provided, a current generated through exposure of the photosensitive member can be made to smoothly flow, with retaining an insulating state to an extent where occurrence of leakage can be inhibited, and hence, increase of resistance can be suppressed.

Examples of the inorganic particles include particles of a metal (such as aluminum, iron, or copper), particles of a metal oxide (such as titanium oxide, alumina, zirconium oxide, tin oxide, or zinc oxide), and particles of a non-metal oxide (such as silica). One type of these organic particles may be used independently, or two or more types of these may be used in combination.

Examples of the intermediate layer resin are the same as the above-described examples of the binder resin. In order to satisfactorily form the intermediate layer and the photosensitive layer, the intermediate layer resin is preferably different from the binder resin contained in the photosensitive layer. The intermediate layer may contain an additive. Examples of the additive contained in the intermediate layer are the same as the above-described examples of the additive contained in the photosensitive layer.

Next, a production method for the photosensitive member will be described. The production method for the photosensitive member includes a step of forming a photosensitive layer directly on a conductive substrate or with an intermediate layer disposed therebetween (photosensitive layer forming step).

(Production Method for Multi-Layer Photosensitive Member)

Now, a production method to be employed when the photosensitive member is a multi-layer photosensitive member will be described. When the photosensitive member is a multi-layer photosensitive member, the photosensitive layer forming step includes a charge generation layer forming step and a charge transport layer forming step.

In the charge generation layer forming step, the charge generation layer containing the charge generating material is formed directly on the conductive substrate or with the intermediate layer disposed therebetween. Specifically, a coating liquid to be used for forming the charge generation layer (hereinafter sometimes referred to as the charge generation layer coating liquid) is prepared. The charge generation layer coating liquid is coated on the conductive substrate. Alternatively, the charge generation layer coating liquid is coated on the intermediate layer provided on the conductive substrate. Next, at least a part of a solvent contained in the charge generation layer coating liquid thus coated is removed to form the charge generation layer. The charge generation layer coating liquid contains, for example, the charge generating material and the solvent. Such a charge generation layer coating liquid is prepared by dissolving or dispersing the charge generating material in the solvent. The charge generation layer coating liquid may further contain the base resin or the additive if necessary.

In the charge transport layer forming step, the charge transport layer containing the hole transport material and the binder resin is formed on the charge generation layer. Specifically, a coating liquid to be used for forming the charge transport layer (hereinafter sometimes referred to as the charge transport layer coating liquid) is prepared. The charge transport layer coating liquid is coated on the charge generation layer. Next, at least a part of a solvent contained in the charge transport layer coating liquid thus coated is removed to form the charge transport layer. The charge transport layer coating liquid contains the hole transport material, the binder resin, and the solvent. The hole transport material contains the compound mixture according to the first embodiment. The charge transport layer coating liquid can be prepared by dissolving or dispersing the hole transport material and the binder resin in the solvent. The charge transport layer coating liquid may further contain the electron acceptor compound and the additive if necessary.

(Production Method for Single-Layer Photosensitive Member)

Now, a production method to be employed when the photosensitive member is a single-layer photosensitive member will be described. When the photosensitive member is a single-layer photosensitive member, the photosensitive layer forming step includes a single-layer photosensitive layer forming step.

In the single-layer photosensitive layer forming step, the single-layer photosensitive layer containing the charge generating material, the hole transport material, and the binder resin is formed directly on the conductive substrate or with the intermediate layer disposed therebetween. Specifically, in the single-layer photosensitive layer forming step, a coating liquid to be used for forming the single-layer photosensitive layer (hereinafter sometimes referred to as the single-layer photosensitive layer coating liquid) is prepared. The single-layer photosensitive layer coating liquid is coated on the conductive substrate. Alternatively, the single-layer photosensitive layer coating liquid is coated on the intermediate layer provided on the conductive substrate. Next, at least a part of a solvent contained in the single-layer photosensitive layer coating liquid thus coated is removed to form the single-layer photosensitive layer. The single-layer photosensitive layer coating liquid contains, for example, the charge generating material, the hole transport material, the binder resin, and the solvent. The hole transport material contains the compound mixture according to the first embodiment. Such a single-layer photosensitive layer coating liquid is prepared by dissolving or dispersing the charge generating material, the hole transport material, and the binder resin in the solvent. The single-layer photosensitive layer coating liquid may further contain the electron transport material and the additive if necessary.

Each of the solvents contained in the charge generation layer coating liquid, the charge transport layer coating liquid, and the single-layer photosensitive layer coating liquid (hereinafter sometimes comprehensively referred to as the “coating liquid”) is not especially limited as long as the respective components to be contained in the coating liquid can be dissolved or dispersed therein. Examples of the solvent to be contained in the coating liquid include alcohol (more specifically, methanol, ethanol, isopropanol, butanol, or the like), aliphatic hydrocarbon (more specifically, n-hexene, octane, cyclohexane, or the like), aromatic hydrocarbon (more specifically, benzene, toluene, xylene, or the like), halogenated hydrocarbon (more specifically, dichloromethane, dichloroethane, carbon tetrachloride, chlorobenzene, or the like), ether (more specifically, dimethyl ether, diethyl ether, tetrahydrofuran, ethylene glycol dimethyl ether, diethylene glycol dimethyl ether, or the like), ketone (more specifically, acetone, methyl ethyl ketone, cyclohexanone, or the like), ester (more specifically, ethyl acetate, methyl acetate, or the like), dimethylformaldehyde, dimethylformamide, and dimethyl sulfoxide. One of these solvents may be used independently, or two or more of these may be used in combination. Among these solvents, a non-halogen solvent (a solvent excluding halogenated hydrocarbon) is preferably used.

The solvent to be contained in the charge transport layer coating liquid is preferably different from the solvent to be contained in the charge generation layer coating liquid. This is because the charge generation layer is preferably not dissolved in the solvent of the charge transport layer coating liquid when the charge transport layer coating liquid is coated on the charge generation layer.

Each of the coating liquids is prepared by mixing the respective components to be dispersed in the solvent. For the mixing and dispersing, for example, a bead mill, a roll mill, a ball mill, an attritor, a paint shaker, or an ultrasonic disperser can be used.

In order to improve dispersibility of the respective components or surface smoothness of the layer to be formed, the coating liquid may contain, for example, a surfactant or a leveling agent.

A method for coating the coating liquid is not especially limited as long as the coating liquid can be uniformly coated. Examples of the coating method include a dip coating method, a spray coating method, a spin coating method, and a bar coating method.

A method for removing at least a part of the solvent contained in the coating liquid is not especially limited as long as the solvent contained in the coating liquid can be evaporated. Examples of the removing method include heating, pressure reduction, and a combination of heating and pressure reduction. A more specific example is a method of performing a heat treatment (hot air drying) using a high-temperature dryer or a vacuum dryer. The temperature for the heat treatment is, for example, at least 40° C. and no greater than 150° C. The time for the heat treatment is, for example, at least 3 minutes and no greater than 120 minutes.

Incidentally, the production method for the photosensitive member may further include a step of forming an intermediate layer and a step of forming a surface layer if necessary. As the step of forming an intermediate layer and the step of forming a surface layer, any of known methods are appropriately selected.

### EXAMPLES

Now, the present disclosure will be more specifically described with reference to examples. It is noted that the present disclosure is not limited by the scope of the examples.

<Preparation of Compound Mixtures>

Compositions of samples (M-A1) to (M-A10) according to examples are shown in a column “HTM” of Table 3 below. Compositions of samples (M-B1) to (M-B7) according to comparative examples are shown in a column “HTM” of Table 4 below.

A preparation method for each of the samples (M-A1) to (M-A10) and (M-B1) to (M-B7) will be described. In the preparation method for each sample described below, compounds represented by the following chemical formulas (A-1) to (A-6), (B-1), (B-2), and (C-1) to (C-3) are sometimes referred to respectively as compounds (A-1) to (A-6), (B-1), (B-2), and (C-1) to (C-3).

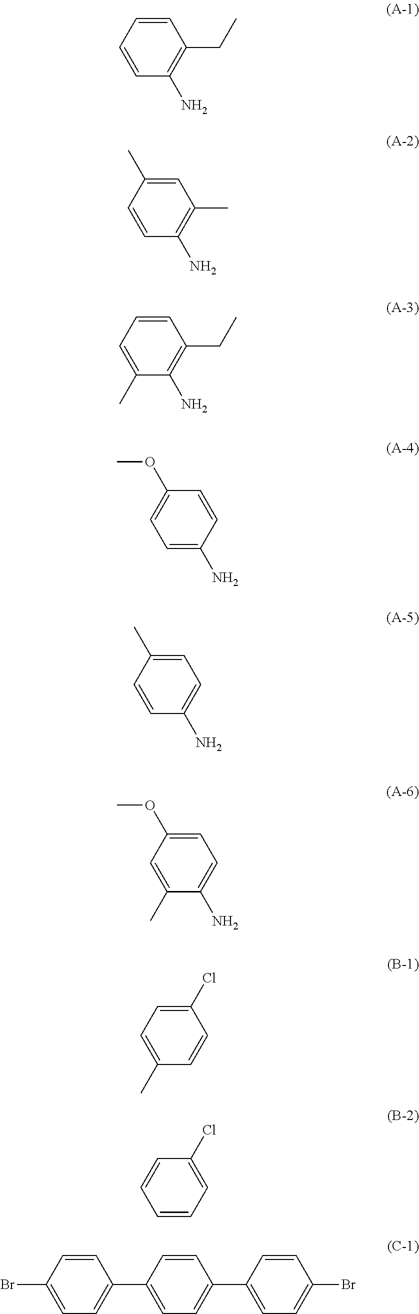

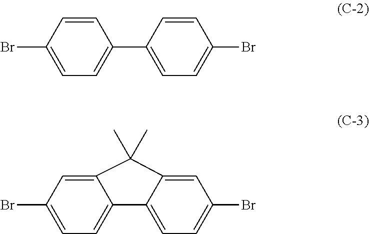 [SMILES: Brc1ccc(-c2ccc(Br)cc2)cc1 ; CC1(C)c2cc(Br)ccc2-c2ccc(Br)cc21]

(Preparation of Sample (M-A1))

The sample (M-A1) was prepared in accordance with the following reaction formula (r-a).

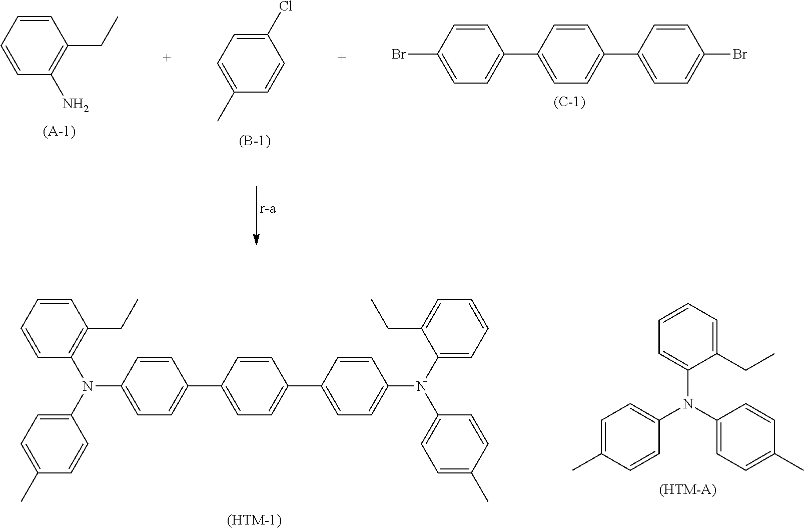

Specifically, a 500-mL three-necked flask equipped with a fractionating tube was charged with tris(dibenzylideneacetone)dipalladium (0.0366 g, 0.040 mmol), 2-dicyclohexylphosphino-2′,4′,6′-triisopropylbiphenyl (0.0763 g, 0.016 mmol), and sodium tert-butoxide (9.669 g, 100.7 mmol). The air in the flask was replaced with a nitrogen gas by performing degassing and nitrogen gas replacement in the flask repeatedly twice.

Subsequently, 2-ethylaniline (compound (A-1), 8.45 g, 69.8 mmol), 4-chlorotoluene (compound (B-1), 10.13 g, 80.0 mmol), and xylene (45 g) were further added into the flask. The resultant liquid thus obtained in the flask was heated to 130° C. for refluxing the liquid. It is noted that the liquid was heated with distilling off tert-butanol generated through the heating. The liquid was stirred (corresponding to first stirring) at 130° C. for 2 hours under reflux. Subsequently, the liquid held in the flask was cooled to 50° C.

Next, sodium tert-butoxide (7.680 g, 80.0 mmol), 4,4″-dibro-p-terphenyl (compound (C-1), 11.60 g, 30.0 mmol), palladium (II) acetate (0.0168 g, 0.075 mmol), 2-dicyclohexylphosphino-2′,4′,6′-triisopropylbiphenyl (0.1425 g, 0.299 mmol), and xylene (32 g) were further added to the liquid in the flask. The resultant liquid was heated to 130° C. for refluxing the liquid in the flask. It is noted that the liquid was heated with distilling off tert-butanol generated through the heating. The liquid was stirred (corresponding to second stirring) at 130° C. for 3 hours under reflux.

Subsequently, the liquid obtained in the flask was cooled to 90° C. Insoluble matter present in the liquid was removed by filtering the liquid held in the flask at 90° C. to obtain a filtrate. The filtrate was subjected to an activated clay treatment twice. In the activated clay treatment, activated clay (“SA-1”, manufactured by Nippon Kassei Hakudo K.K., 8 g) was put into the filtrate, and the resultant was stirred at 110° C. for 15 minutes and filtered again to collect a filtrate. The filtrate having been subjected to the activated clay treatment twice was concentrated under reduced pressure to obtain a concentrate. To the concentrate, isohexane in an amount for slightly clouding the concentrate (about 50 g) was added, and then methanol (50 g) was added thereto. The resultant concentrate was cooled to 5° C., and the thus precipitated crystal was taken out by filtering. To the obtained crystal, xylene (100 g) was added, and the resultant was heated to 110° C. to dissolve the crystal in xylene. Thus, a solution was obtained. The solution was subjected to activated clay treatment five times. A filtrate obtained by performing the activated clay treatment five times was concentrated under reduced pressure to obtain a concentrate. To the concentrate, isohexane in an amount for slightly clouding the concentrate (about 50 g) was added, and then methanol (50 g) was added thereto. The resultant concentrate was cooled to 5° C., and the thus precipitated crystal was taken out by filtering. The obtained crystal was dried under vacuum at 70° C. for 24 hours to obtain the sample (M-A1). The sample (M-A1) was a compound mixture containing the compound (HTM-1) and the compound (HTM-A). A yield of the sample (M-A1) was 16.3 g. A yield ratio of the compound (HTM-1) contained in the sample (M-A1) with respect to the compound (C-1) was 84%.

(Preparation of Sample (M-A2))

The sample (M-A2) was obtained in the same manner as in the preparation of the sample (M-A1) in all aspect except that 69.8 mmol of the compound (A-1) was changed to 69.8 mmol of the compound (A-2). The sample (M-A2) was a compound mixture containing the compound (HTM-2) and the compound (HTM-B).

(Preparation of Sample (M-A3))

The sample (M-A3) was obtained in the same manner as in the preparation of the sample (M-A1) in all aspect except that 69.8 mmol of the compound (A-1) was changed to 69.8 mmol of the compound (A-3). The sample (M-A3) was a compound mixture containing the compound (HTM-3) and the compound (HTM-C).

(Preparation of Sample (M-A4))

The sample (M-A4) was obtained in the same manner as in the preparation of the sample (M-A1) in all aspect except that 69.8 mmol of the compound (A-1) was changed to 69.8 mmol of the compound (A-4) and that 80.0 mmol of the compound (B-1) was changed to 80.0 mmol of the compound (B-2). The sample (M-A4) was a compound mixture containing the compound (HTM-4) and the compound (HTM-D).

(Preparation of Sample (M-A5))

The sample (M-A5) was obtained in the same manner as in the preparation of the sample (M-A1) in all aspect except that 69.8 mmol of the compound (A-1) was changed to 69.8 mmol of the compound (A-5), that 80.0 mmol of the compound (B-1) was changed to 80.0 mmol of the compound (B-2), and that 30.0 mmol of the compound (C-1) was changed to 30.0 mmol of the compound (C-2). The sample (M-A5) was a compound mixture containing the compound (HTM-5) and the compound (HTM-E).

(Preparation of Sample (M-A6))

The sample (M-A6) was obtained in the same manner as in the preparation of the sample (M-A1) in all aspect except that 69.8 mmol of the compound (A-1) was changed to 69.8 mmol of the compound (A-6), that 80.0 mmol of the compound (B-1) was changed to 80.0 mmol of the compound (B-2), and that 30.0 mmol of the compound (C-1) was changed to 30.0 mmol of the compound (C-3). The sample (M-A6) was a compound mixture containing the compound (HTM-6) and the compound (HTM-F).

(Preparation of Sample (M-A7))

The sample (M-A7) was obtained in the same manner as in the preparation of the sample (M-A1) in all aspect except that 80.0 mmol of the compound (B-1) was changed to 75.0 mmol of the compound (B-1). The sample (M-A7) was a compound mixture containing the compound (HTM-1) and the compound (HTM-A).

(Preparation of Sample (M-A8))

The sample (M-A8) was obtained in the same manner as in the preparation of the sample (M-A1) in all aspect except that 69.8 mmol of the compound (A-1) was changed to 76.8 mmol of the compound (A-1) and that 80.0 mmol of the compound (B-1) was changed to 93.5 mmol of the compound (B-1). The sample (M-A8) was a compound mixture containing the compound (HTM-1) and the compound (HTM-A).

(Preparation of Sample (M-A9))

The sample (M-A9) was obtained in the same manner as in the preparation of the sample (M-A1) in all aspect except that 69.8 mmol of the compound (A-1) was changed to 94.2 mmol of the compound (A-1), and that 80.0 mmol of the compound (B-1) was changed to 128.25 mmol of the compound (B-1). The sample (M-A9) was a compound mixture containing the compound (HTM-1) and the compound (HTM-A).

(Preparation of Sample (M-A10))

The sample (M-A10) was obtained in the same manner as in the preparation of the sample (M-A1) in all aspect in all aspect except that 69.8 mmol of the compound (A-1) was changed to 97.7 mmol of the compound (A-1) and that 80.0 mmol of the compound (B-1) was changed to 140.0 mmol of the compound (B-1). The sample (M-A10) was a compound mixture containing the compound (HTM-1) and the compound (HTM-A).

(Preparation of Sample (M-B1))

The sample (M-A1) was purified by silica gel column chromatography using, as a developing solvent, a mixed solvent of toluene and isohexane (volume ratio of 50/50). Thus, a fraction containing the compound (HTM-1) was isolated. The thus isolated liquid (fraction) was concentrated under reduced pressure until the liquid was slightly clouded, and thus, a concentrate was obtained. Isohexane and methanol were added to the concentrate. The resultant concentrate was cooled to 5° C., and the thus precipitated crystal was taken out by filtering to obtain the sample (M-B1). The sample (M-B1) did not contain the compound (HTM-A) but contained the compound (HTM-1) alone.

(Preparation of Sample (M-B2))

The sample (M-B2) was obtained in the same manner as in the preparation of the sample (M-B1) in all aspect except that the sample (M-A1) was changed to the sample (M-A2). The sample (M-B2) did not contain the compound (HTM-B) but contained the compound (THM-2) alone.

(Preparation of Sample (M-B3))

The sample (M-B3) was obtained in the same manner as in the preparation of the sample (M-B1) in all aspect except that the sample (M-A1) was changed to the sample (M-A3). The sample (M-B3) did not contain the compound (HTM-C) but contained the compound (THM-3) alone.

(Preparation of Sample (M-B4))

The sample (M-B4) was obtained in the same manner as in the preparation of the sample (M-B1) in all aspect except that the sample (M-A1) was changed to the sample (M-A4). The sample (M-B4) did not contain the compound (HTM-D) but contained the compound (THM-4) alone.

(Preparation of Sample (M-B5))

The sample (M-B5) was obtained in the same manner as in the preparation of the sample (M-B1) in all aspect except that the sample (M-A1) was changed to the sample (M-A5). The sample (M-B5) did not contain the compound (HTM-E) but contained the compound (THM-5) alone.

(Preparation of Sample (M-B6))

The sample (M-B6) was obtained in the same manner as in the preparation of the sample (M-B1) in all aspect except that the sample (M-A1) was changed to the sample (M-A6). The sample (M-B6) did not contain the compound (HTM-F) but contained the compound (THM-6) alone.

(Preparation of Sample (M-B7))

The sample (M-A1) was purified by silica gel column chromatography using, as a developing solvent, a mixed solvent of toluene and isohexane (volume ratio of 50/50). Thus, a fraction containing the compound (HTM-A) was isolated. The thus isolated liquid (fraction) was concentrated under reduced pressure until the liquid was slightly clouded, and thus, a concentrate was obtained. Isohexane and methanol were added to the concentrate. The resultant concentrate was cooled to 5° C., and the thus precipitated crystal was taken out by filtering to obtain the sample (M-B7). The sample (M-B7) did not contain the compound (HTM-1) but contained the compound (HTM-A) alone.

(Measurement of Content Ratios of Compound (1) and Compound (2))

In each of the samples prepared as described above, a content ratio of the compound (1) with respect to the total mass of the compound (1) and the compound (2) was measured. Besides, in each of the samples prepared as described above, a content ratio of the compound (2) with respect to the total mass of the compound (1) and the compound (2) was measured. As the content ratio of the compound (1), a content ratio of each of the compounds (HTM-1) to (HTM-6) encompassed in those represented by the general formula (1) was measured. Besides, as the content ratio of the compound (2), a content ratio of each of the compounds (HTM-1) to (HTM-F) encompassed in those represented by the general formula (2) was measured. The measurement was performed as follows.

A tetrahydrofuran solution was obtained by dissolving 2.0 mg of any sample (more specifically, any one of the samples (M-A1) to (M-A10) and (M-B1) to (M-B7)) in 670 mg of tetrahydrofuran. It is noted that the tetrahydrofuran used did not contain a stabilizer. The thus obtained tetrahydrofuran solution was analyzed by high performance liquid chromatography (HPLC). Specifically, the tetrahydrofuran solution of each sample was analyzed using an analyzer under analysis conditions described below to obtain a HPLC chart. Based on a peak area of the compound (1) in the HPLC chart, a content of the compound (1) was obtained. Based on a peak area of the compound (2) in the HPLC chart, a content of the compound (2) was obtained. Based on the content of the compound (1) and the content of the compound (2) thus obtained, the content ratio of the compound (1) and the content ratio of the compound (2) were calculated. The results of the calculation are shown in a column “Content Ratio” of Tables 3 to 5.

(Analyzer and Analysis Conditions)
Analyzer: “LaChrom ELITE”, manufactured by Hitachi High-Technologies Corporation
Detection Wavelength: 254 nm
Column: “INERTSIL (registered Japanese trademark) ODS-3” (manufactured by GL Sciences Inc., inside diameter: 4.6 mm, length: 250 mm)
Column Temperature: 40° C.
Developing Solvent: acetonitrile
Flow Rate: 1 mL/min
Sample Injection Amount: 1 μL

<Synthesis of Binder Resin>

Next, polyarylate resins (R-1) to (R-4) were synthesized. These polyarylate resins were used in “Production of Multi-layer Photosensitive Member” described later.

(Polyarylate Resin (R-1))

The polyarylate resin (R-1) included, as repeating units, merely the repeating units (10-1), (11-X1), and (11-X3). The polyarylate resin (R-1) included two repeating units (11) of the repeating units (11-X1) and (11-X3), and the ratio p was 0.50. The viscosity average molecular weight of the polyarylate resin (R-1) was 50,500.

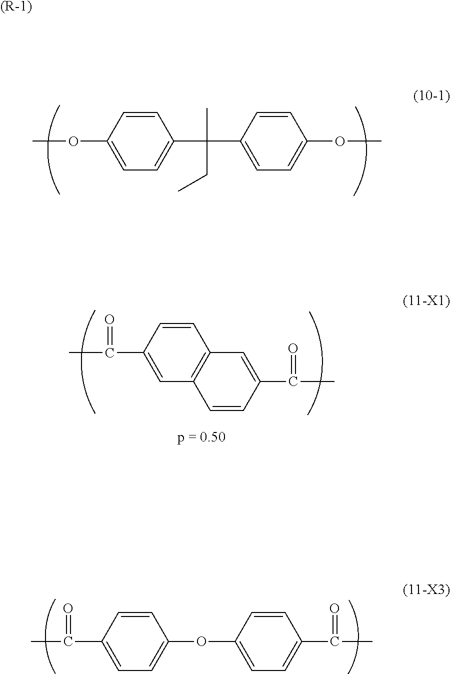

As a reaction vessel, a 1-L three-necked flask equipped with a thermometer, a three-way cock, and a 200-mL dropping funnel was used. The reaction vessel was charged with 10 g (41.28 mmol) of the compound (BP-10-1), 0.062 g (0.413 mmol) of tert-butylphenol, 3.92 g (98 mmol) of sodium hydroxide, and 0.120 g (0.384 mmol) of benzyl tributyl ammonium chloride. The air in the reaction vessel was replaced with an argon gas. To the resultant contents of the reaction vessel, 300 mL of water was added. The resultant contents of the reaction vessel were stirred at 50° C. for 1 hour. Subsequently, the contents of the reaction vessel were cooled until the temperature of the contents was 10° C., and thus, an alkaline aqueous solution A was obtained.

In 150 mL of chloroform, 4.10 g (16.2 mmol) of 2,6-naphthalene dicarboxylic acid dichloride (dichloride of the compound (DC-11-X1)) and 4.78 g (16.2 mmol) of 4,4′-oxybisbenzoic acid dichloride (dichloride of the compound (DC-11-X3)) were dissolved. Thus, a chloroform solution B was obtained.

The chloroform solution B was slowly added in a dropwise manner through a dropping funnel to the alkaline aqueous solution A over 110 minutes. With the temperature (liquid temperature) of the contents of the reaction vessel adjusted to 15±+5° C., the contents of the reaction vessel were stirred for 4 hours to cause a polymerization reaction to proceed. Subsequently, an upper layer (aqueous layer) of the contents of the reaction vessel was removed with a decanter to obtain an organic layer. Then, a 1-L Erlenmeyer flask was charged with 400 mL of ion exchanged water. The organic layer obtained as described above was added to the contents of the flask. To the resultant contents of the flask, 400 mL of chloroform and 2 mL of acetic acid were further added. Subsequently, the resultant contents of the flask were stirred at room temperature (25° C.) for 30 minutes. Thereafter, an upper layer (aqueous layer) of the contents of the flask was removed with a decanter to obtain an organic layer. The thus obtained organic layer was washed with 1 L of ion exchanged water using a separatory funnel. The washing with ion exchanged water was repeated five times, and thus, a washed organic layer was obtained.

Next, the washed organic layer was filtered to obtain a filtrate. A 1-L beaker was charged with 1 L of methanol. The filtrate obtained as described above was slowly added in a dropwise manner to methanol held in the beaker to obtain a precipitate. The thus obtained precipitate was taken out by filtering. The precipitate thus taken out was dried in vacuum at a temperature of 70° C. for 12 hours. As a result, the polyarylate resin (R-1) was obtained.

(Polyarylate Resin (R-2))

The polyarylate resin (R-2) included, as repeating units, merely the repeating units (10-2), (11-X1), and (11-X3). The polyarylate resin (R-2) included two repeating units (11) of the repeating units (11-X1) and (11-X3), and the ratio p was 0.50. The viscosity average molecular weight of the polyarylate resin (R-2) was 47,500.

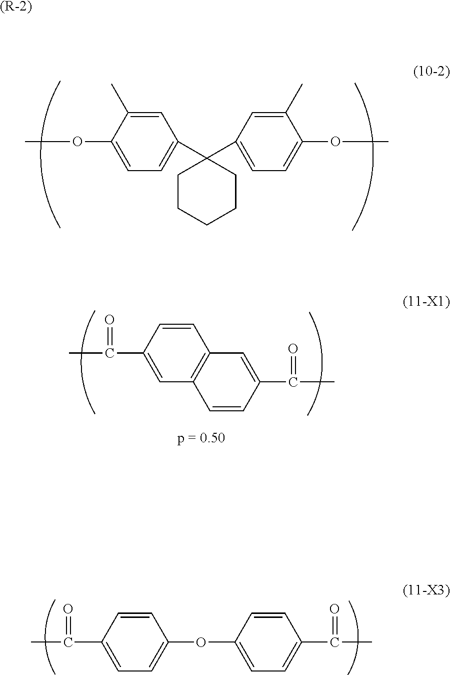

The polyarylate resin (R-2) was obtained in the same manner as in the synthesis of the polyarylate resin (R-1) in all aspect except that 41.28 mmol of the compound (BP-10-1) was changed to 41.28 mmol of the compound (BP-10-2).

(Polyarylate Resin (R-3))

The polyarylate resin (R-3) included, as repeating units, merely the repeating units (10-2), (11-X1), and (11-X2). The polyarylate resin (R-3) included two repeating units (11) of the repeating units (11-X1) and (11-X2), and the ratio p was 0.50. The viscosity average molecular weight of the polyarylate resin (R-3) was 50,500.

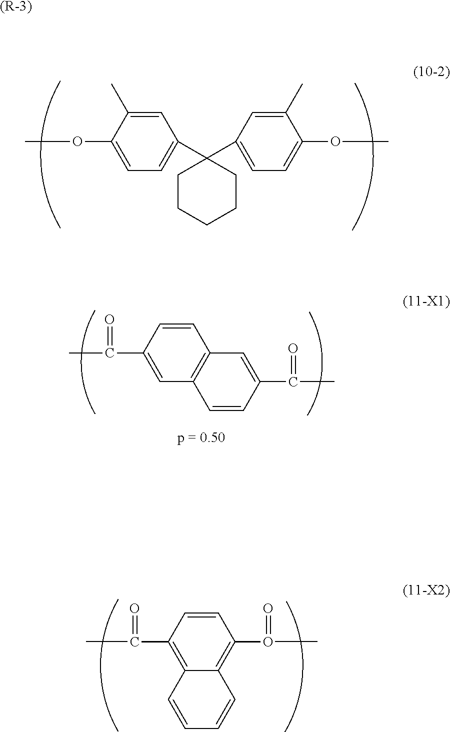

The polyarylate resin (R-3) was obtained in the same manner as in the synthesis of the polyarylate resin (R-1) in all aspect except that 41.28 mmol of the compound (BP-10-1) was changed to 41.28 mmol of the compound (BP-10-2) and that 16.2 mmol of the dichloride of the compound (DC-11-X3) was changed to 16.2 mmol of dichloride of the compound (DC-11-X2).

(Polyarylate Resin (R-4))

The polyarylate resin (R-4) included, as repeating units, merely the repeating units (10-1), (10-3), and (11-X3). The polyarylate resin (R-4) had a ratio p of 0.80. The viscosity average molecular weight of the polyarylate resin (R-4) was 50,500.

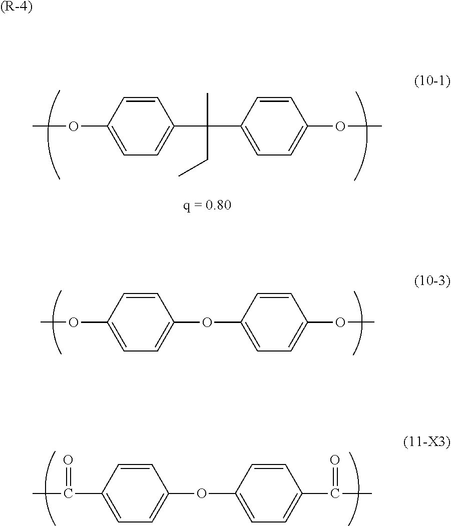

The polyarylate resin (R-4) was obtained in the same manner as in the synthesis of the polyarylate resin (R-1) in all aspect except that 41.28 mmol of the compound (BP-10-1) was changed to 33.02 mmol of the compound (BP-10-1) and that 16.2 mmol of the dichloride of the compound (DC-11-X1) was changed to 32.4 mmol of dichloride of the compound (DC-11-X3).

<Production of Multi-Layer Photosensitive Members>

(Production of Multi-Layer Photosensitive Member (A-1))

First, an intermediate layer was formed. Surface treated titanium oxide (“Prototype SMT-A”, manufactured by Tayca Corporation, number average primary particle diameter: 10 nm) was prepared. The SMT-A was a product obtained by surface treating titanium oxide with alumina and silica, and further surface treating the thus surface treated titanium oxide with methyl hydrogen polysiloxane with wet dispersion. Next, 2 parts by mass of the SMT-A, 1 part by mass of a polyamide resin (“AMILAN (registered Japanese trademark) CM8000”, manufactured by Toray Industries, Inc., quaternary copolymerized polyamide resin of a polyamide 6, a polyamide 12, a polyamide 66, and a polyamide 610), 10 parts by mass of methanol, 1 part by mass of butanol, and 1 part by mass of toluene were mixed using a bead mill for hours to obtain an intermediate layer coating liquid. The intermediate layer coating liquid was filtered through a filter having an opening of 5 μm. Thereafter, the resultant intermediate layer coating liquid was coated on a surface of a conductive substrate by the dip coating method. The conductive substrate was an aluminum drum-shaped support (having a diameter of 30 mm and a total length of 246 mm). Subsequently, the intermediate layer coating liquid thus coated was dried at 130° C. for 30 minutes to form an intermediate layer (having a thickness of 2 m) on the conductive substrate.

Next, a charge generation layer was formed. Specifically, 1.5 parts by mass of Y-form titanyl phthalocyanine used as the charge generating material, 1.0 part by mass a polyvinyl acetal resin (“SLEC BX-5”, manufactured by Sekisui Chemical Co., Ltd.) used as the base resin, 40.0 parts by mass of propylene glycol monomethyl ether, and 40.0 parts by mass of tetrahydrofuran were mixed using a bead mill for 2 hours to obtain a charge generation layer coating liquid. The charge generation layer coating liquid was filtered through a filter having an opening of 3 μm. The thus obtained filtrate was coated on the intermediate layer by the dip coating method, and the resultant was dried at 50° C. for 5 minutes. Thus, a charge generation layer (having a thickness of 0.3 m) was formed on the intermediate layer.

Next, a charge transport layer was formed. Specifically, 100.00 parts by mass of the sample (M-A1) used as the hole transport material, 100.00 parts by mass of the polyarylate resin (R-1) used as the binder resin, 2.00 parts by mass of the compound (E-1) used as the electron acceptor compound, 0.50 parts by mass of a hindered phenol antioxidant (“IRGANOX (registered Japanese trademark) 1010”, manufactured by BASF), 0.05 parts by mass of a leveling agent (dimethyl silicone oil, “KF96-50CS”, manufactured by Shin-Etsu Chemical Co., Ltd.), 350.00 parts by mass of tetrahydrofuran, and 350.00 parts by mass of toluene were mixed to obtain a charge transport layer coating liquid. The charge transport layer coating liquid was coated on the charge generation layer by the dip coating method, and the resultant was dried at 120° C. for 40 minutes. Thus, a charge transport layer (having a thickness of 20 μm) was formed on the charge generation layer. As a result, a multi-layer photosensitive member (A-1) was obtained. In the multi-layer photosensitive member (A-1), the intermediate layer was provided on the conductive substrate, the charge generation layer was provided on the intermediate layer, and the charge transport layer was provided on the charge generation layer.

(Production of Multi-Layer Photosensitive Members (A-2) to (A-6), (A-10) to (A-13), and (B-1) to (B-7))

Multi-layer photosensitive members (A-2) to (A-6), (A-10) to (A-13), and (B-1) to (B-7) were produced in the same manner as in the production of the multi-layer photosensitive member (A-1) in all aspect except that the sample (M-A1) was changed to the respective samples shown in a column “Sample No.” of Tables 3 and 4. In the production of, for example, the multi-layer photosensitive member (A-2), the sample (M-A1) was changed to the sample (M-A2) shown in the column “Sample No.” of Table 3.

(Production of Multi-Layer Photosensitive Members (A-7) to (A-9))

Multi-layer photosensitive members (A-7) to (A-9) were produced in the same manner as in the production of the multi-layer photosensitive member (A-1) in all aspect except that the polyarylate resin (R-1) was changed to the respective binder resins shown in a column “Resin” of Tables 3 and 4. In the production of, for example, the multi-layer photosensitive member (A-7), the polyarylate resin (R-1) was changed to the polyarylate resin (R-2) shown in the column “Resin” of Table 3.

<Evaluation of Charging Characteristics>

Each of the multi-layer photosensitive members (A-1) to (A-13) and (B-1) to (B-7) was evaluated for charging characteristics under an environment of a temperature of 10° C. and a relative humidity of 20%. Specifically, a drum sensitivity tester (manufactured by Gentec Co.) was used to charge each multi-layer photosensitive member under conditions of a rotational speed of the multi-layer photosensitive member of 31 rpm and a current flowing into the multi-layer photosensitive member of −10 pA. The surface potential of the thus charged multi-layer photosensitive member was measured. The surface potential thus measured was defined as charge potential (V₀, unit: −V) of the multi-layer photosensitive member. The charge potentials (V₀) of the respective multi-layer photosensitive members thus measured are shown in Tables 3 and 4.

<Evaluation of Sensitivity Characteristics>

Each of the multi-layer photosensitive members (A-1) to (A-13) and (B-1) to (B-7) was evaluated for sensitivity characteristics under an environment of a temperature of 10° C. and a relative humidity of 20%. Specifically, a drum sensitivity tester (manufactured by Gentec Co.) was used to charge the surface of each multi-layer photosensitive member to −600 V. Subsequently, monochromatic light (wavelength: 780 nm, exposure amount: 0.8 μJ/cm²) was taken out of light of a halogen lamp using a band-pass filter to irradiate the surface of the multi-layer photosensitive member. After elapse of 120 milliseconds after completion of the irradiation with the monochromatic light, the surface potential of the multi-layer photosensitive member was measured. The surface potential thus measured was defined as post-exposure potential (V_{L}, unit: −V). The post-exposure potentials (V_{L}) of the respective photosensitive members are shown in Tables 3 and 4. The sensitivity characteristics of each laminate photosensitive member was evaluated based on the absolute value of the post-exposure potential (V_{L}) on the basis of the following criteria:

Good: The absolute value of the post-exposure potential is no greater than 170 V.

Poor: The absolute value of the post-exposure potential is over 170 V.

<Evaluation of Crystallization Inhibition>

The whole photosensitive layer of each of the multi-layer photosensitive members (A-1) to (A-13) and (B-1) to (B-7) was visually observed. Thus, it was checked whether or not any portion of the photosensitive layer had been crystallized. Based on the result of the observation, it was evaluated, on the basis of the following criteria, whether or not crystallization was inhibited in the multi-layer photosensitive member. The results of the evaluation are shown in Tables 3 and 4.

Evaluation A: No crystallized portion was visually found.

Evaluation B: A crystallized portion was visually found.

<Evaluation of Crack Resistance>

Each of the multi-layer photosensitive members (A-1) to (A-13) and (B-1) to (B-7) was evaluated for crack resistance. Specifically, a region of each multi-layer photosensitive member located 40 mm from its lower end was immersed in an isoparaffin-based hydrocarbon solvent (“ISOPAR L”, manufactured by Exxon Mobil Corporation) for 24 hours under an environment of a temperature of 23° C. and a relative humidity of 50%. After the 24-hour immersion, the number of cracks caused on the surface of the multi-layer photosensitive member was counted. Based on the number of cracks, the crack resistance was evaluated on the basis of the following criteria:

Evaluation A: The number of cracks is no greater than 20.

Evaluation B: The number of cracks is over 20.

In a column “HTM” of Tables 3 to 5, a hole transport material is shown. In a column “Compound (1)” of a column “Content Ratio” of Tables 3 to 5, a content ratio (unit: % by mass) of the compound (1) with respect to the total mass of the compound (1) and the compound (2) is shown. In a column “Compound (2)” of the column “Content Ratio” of Tables 3 to 5, a content ratio (unit: % by mass) of the compound (2) with respect to the total mass of the compound (1) and the compound (2) is shown. In a column “Resin” of Tables 3 to 5, a binder resin is shown. In a column “EA” of Tables 3 to 5, an electron acceptor compound is shown. In a column “V₀” of Tables 3 and 4, charge potential is shown. In a column “V_{L}” of Tables 3 and 4, post-exposure potential is shown. In a column “Crystallization” of Tables 3 and 4, an evaluation result for the crystallization inhibition is shown. In a column “Crack” of Tables 3 and 4, an evaluation result for the crack resistance is shown.

TABLE 3

| | Charge Transport Layer | | | | | | | | | | |
|---|---|---|---|---|---|---|---|---|---|---|---|
| | HTM | | | | | | | | | | |
| | | | | Content Ratio | | | | | | | |
| Multi-layer | | | | [% by mass] | | | | Evaluation | | | |
| Photosensitive | Sample | Compound | Compound | Compound | Compound | | | V₀ | V_{L} | | |
| Member | No. | (1) | (2) | (1) | (2) | Resin | EA | [−V] | [−V] | Crystallization | Crack |
| A-1 | M-A1 | HTM-1 | HTM-A | 96.2 | 3.8 | R-1 | E-1 | 660 | 97 | A | A |
| A-2 | M-A2 | HTM-2 | HTM-B | 96.1 | 3.9 | R-1 | E-1 | 650 | 95 | A | A |
| A-3 | M-A3 | HTM-3 | HTM-C | 95.8 | 4.2 | R-1 | E-1 | 675 | 97 | A | A |
| A-4 | M-A4 | HTM-4 | HTM-D | 97.5 | 2.5 | R-1 | E-1 | 669 | 95 | A | A |
| A-5 | M-A5 | HTM-5 | HTM-E | 96.2 | 3.8 | R-1 | E-1 | 674 | 145 | A | A |
| A-6 | M-A6 | HTM-6 | HTM-F | 97.5 | 2.5 | R-1 | E-1 | 668 | 167 | A | A |
| A-7 | M-A1 | HTM-1 | HTM-A | 96.2 | 3.8 | R-2 | E-1 | 659 | 95 | A | A |
| A-8 | M-A1 | HTM-1 | HTM-A | 96.2 | 3.8 | R-3 | E-1 | 660 | 96 | A | A |
| A-9 | M-A1 | HTM-1 | HTM-A | 96.2 | 3.8 | R-4 | E-1 | 683 | 94 | A | A |
| A-10 | M-A7 | HTM-1 | HTM-A | 98.9 | 1.1 | R-1 | E-1 | 697 | 94 | A | A |
| A-11 | M-A8 | HTM-1 | HTM-A | 93.0 | 7.0 | R-1 | E-1 | 658 | 97 | A | A |
| A-12 | M-A9 | HTM-1 | HTM-A | 88.8 | 11.2 | R-1 | E-1 | 653 | 108 | A | A |
| A-13 | M-A10 | HTM-1 | HTM-A | 74.8 | 25.2 | R-1 | E-1 | 654 | 128 | A | A |

TABLE 4

| | Charge Transport Layer | | | | | | | | | | |
|---|---|---|---|---|---|---|---|---|---|---|---|
| | HTM | | | | | | | | | | |
| | | | | Content Ratio | | | | | | | |
| Multi-layer | | | | [% by mass] | | | | Evaluation | | | |
| Photosensitive | Sample | Compound | Compound | Compound | Compound | | | V₀ | V_{L} | | |
| Member | No. | (1) | (2) | (1) | (2) | Resin | EA | [−V] | [−V] | Crystallization | Crack |
| B-1 | M-B1 | HTM-1 | — | 100.0 | 0.0 | R-1 | E-1 | 664 | 90 | A | B |
| B-2 | M-B2 | HTM-2 | — | 100.0 | 0.0 | R-1 | E-1 | 677 | 95 | B | B |
| B-3 | M-B3 | HTM-3 | — | 100.0 | 0.0 | R-1 | E-1 | 666 | 94 | A | B |
| B-4 | M-B4 | HTM-4 | — | 100.0 | 0.0 | R-1 | E-1 | 652 | 94 | A | B |
| B-5 | M-B5 | HTM-5 | — | 100.0 | 0.0 | R-1 | E-1 | 680 | 153 | A | B |
| B-6 | M-B6 | HTM-6 | — | 100.0 | 0.0 | R-1 | E-1 | 687 | 159 | B | B |
| B-7 | M-B7 | — | HTM-A | 0.0 | 100.0 | R-1 | E-1 | 692 | 412 | A | A |
| | | | | | | | | | (defect) | | |

As shown in Table 3, each of the samples (M-A1) to (M-A10) was a compound mixture containing the compound (1) (more specifically, any one of the compounds (HTM-1) to (HTM-6)) and the compound (2) (more specifically, any one of the compounds (HTM-A) to (HTM-F)). The samples (M-A1) to (M-A10) of the compound mixtures were each contained in the charge transport layer of a corresponding one of the multi-layer photosensitive members (A-1) to (A-13). Therefore, the multi-layer photosensitive members (A-1) to (A-13) were evaluated as A in the crack resistance, and thus excellent in the crack resistance. Besides, the multi-layer photosensitive members (A-1) to (A-13) each had a post-exposure potential having an absolute value no greater than 170 V, and thus excellent in the sensitivity characteristics.

As shown in Table 4, each of the samples (M-B1) to (M-B6) did not contain the compound (2). The samples (M-B1) to (M-B6) were respectively contained in the charge transport layers of the multi-layer photosensitive members (B-1) to (B-6). Therefore, the multi-layer photosensitive members (B-1) to (B-6) were evaluated as B in the crack resistance, and thus, poor in the crack resistance.

As shown in Table 4, the sample (M-B7) did not contain the compound (1). The sample (M-B7) was contained in the charge transport layer of the multi-layer photosensitive member (B-7). Therefore, the multi-layer photosensitive member (B-7) had a post-exposure potential having an absolute value over 170, and thus poor in the sensitivity characteristics.

Based on these results, it was revealed that the compound mixture according to the present disclosure and the compound mixture produced by the production method according to the present disclosure can improve the crack resistance and the sensitivity characteristics of a photosensitive member when contained in a photosensitive layer. Besides, it was also revealed that a photosensitive member containing the compound mixture of the present disclosure is excellent in the crack resistance and the sensitivity characteristics.

Incidentally, it was confirmed, based on the evaluation results for the charging characteristics shown in Table 3, that the multi-layer photosensitive members (A-1) to (A-13) each had a charge potential having an absolute value of at least 650 V and no greater than 697 V, which is suitable for practical use.

It was confirmed, based on the evaluation results for the crystallization inhibition of the multi-layer photosensitive member (A-2) of Table 3 and the laminate photosensitive member (B-2) of Table 4, that the crystallization is inhibited in the sample (M-A2) corresponding to the compound mixture containing the compound (HTM-2) and the compound (HTM-B) as compared with the sample (M-B2) containing the compound (HTM-2) but not containing the compound (HTM-B). Besides, it was confirmed, based on the evaluation results for the crystallization inhibition of the multi-layer photosensitive member (A-6) of Table 3 and the laminate photosensitive member (B-6) of Table 4, that the crystallization is inhibited in the sample (M-A6) corresponding to the compound mixture containing the compound (HTM-6) and the compound (HTM-F) as compared with the sample (M-B6) containing the compound (HTM-6) but not containing the compound (HTM-F).

<Evaluation of Abrasion Resistance>

Next, the abrasion resistance was evaluated by using the multi-layer photosensitive members (A-1) and (A-7) to (A-9) containing different binder resins. For the evaluation of the abrasion resistance, a color printer (“C711dn”, manufactured by Oki Data Corporation) was used as an evaluation apparatus. A cyan toner was loaded in a toner cartridge of the evaluation apparatus. First, a thickness T1 of the charge transport layer of each multi-layer photosensitive member was measured. Then, the multi-layer photosensitive member was loaded in the evaluation apparatus. Subsequently, an image was printed on 30,000 sheets using the evaluation apparatus under an environment of a temperature of 23° C. and a relative humidity of 50%. After the printing, a thickness T2 of the charge transport layer of the multi-layer photosensitive member was measured. Then, abrasion loss (T1-T2, unit: μm) corresponding to a thickness change of the charge transport layer caused through the printing was obtained. The abrasion loss is shown in Table 5. As the abrasion loss is smaller, the abrasion resistance of the multi-layer photosensitive member is better.

TABLE 5

| | Charge Transport Layer | | | | | | | |
|---|---|---|---|---|---|---|---|---|
| | HTM | | | | | | | |
| | | | | Content Ratio [% by mass] | | | | Evaluation |
| Multi-layer | | | | | | | | Abrasion |
| Photosensitive | Sample | Compound | Compound | Compound | Compound | | | Loss |
| Member | No. | (1) | (2) | (1) | (2) | Resin | EA | [μm] |
| A-1 | M-A1 | HTM-1 | HTM-A | 96.2 | 3.8 | R-1 | E-1 | 3.0 |
| A-7 | M-A1 | HTM-1 | HTM-A | 96.2 | 3.8 | R-2 | E-1 | 3.4 |
| A-8 | M-A1 | HTM-1 | HTM-A | 96.2 | 3.8 | R-3 | E-1 | 3.5 |
| A-9 | M-A1 | HTM-1 | HTM-A | 96.2 | 3.8 | R-4 | E-1 | 2.5 |

As shown in Table 5, the multi-layer photosensitive member (A-9) containing the polyarylate resin (R-4) was excellent in the abrasion resistance as compared with the multi-layer photosensitive members (A-1), (A-7), and (A-8) respectively containing the polyarylate resins (R-1) to (R-3).

What is claimed is:

1. A compound mixture comprising a mixture of a compound represented by general formula (1) and a compound represented by general formula (2): 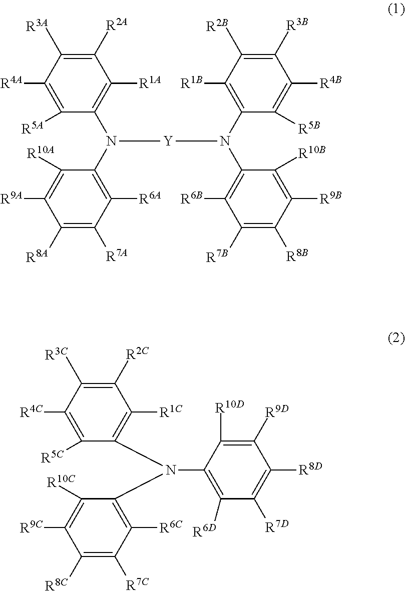
where, in the general formula (1), R^{1A}, R^{2A}, R^{3A}, R^{4A}, R^{5A}, R^{6A}, R^{7A}, R^{8A}, R^{9A} and R^{10A} each represent, independently of one another, a hydrogen atom, an alkyl group having a carbon number of at least 1 and no greater than 8, an alkoxy group having a carbon number of at least 1 and no greater than 8, or an aryl group having a carbon number of at least 6 and no greater than 14;
R^{1B} in the general formula (1) and R^{1C} in the general formula (2) represent the same group as R^{1A} in the general formula (1);
R^{2B} in the general formula (1) and R^{2C} in the general formula (2) represent the same group as R^{2A} in the general formula (1);
R^{3B} in the general formula (1) and R^{3C} in the general formula (2) represent the same group as R^{3A} in the general formula (1);
R^{4B} in the general formula (1) and R^{4C} in the general formula (2) represent the same group as R^{4A} in the general formula (1);
R^{5B} in the general formula (1) and R^{5C} in the general formula (2) represent the same group as R^{5A} in the general formula (1);
R^{6B} in the general formula (1) and R^{6C} and R^{6D} in the general formula (2) represent the same group as R^{6A} in the general formula (1);
R^{7B} in the general formula (1) and R^{7C} and R^{7D} in the general formula (2) represent the same group as R^{7A} in the general formula (1);
R^{8B} in the general formula (1) and R^{8C} and R^{8D} in the general formula (2) represent the same group as R^{8A} in the general formula (1);
R^{9B} in the general formula (1) and R^{9C} and R^{9D} in the general formula (2) represent the same group as R^{9A} in the general formula (1);
R^{10B} in the general formula (1) and R^{10C} and R^{10D} in the general formula (2) represent the same group as R^{10A} in the general formula (1); and
Y in the general formula (1) represents a bivalent group represented by chemical formula (Y1), chemical formula (Y2), or general formula (Y3): 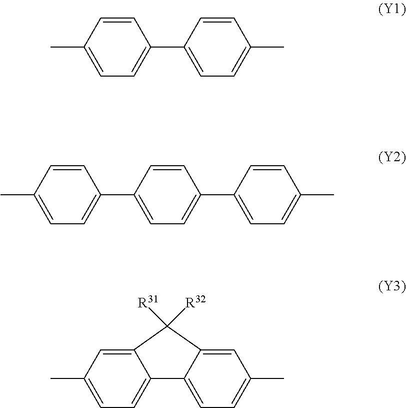
where R³¹ and R³² in the general formula (Y3) each represent, independently of one another, a hydrogen atom, an alkyl group having a carbon number of at least 1 and no greater than 8, or a phenyl group.

2. The compound mixture according to claim 1, wherein
Y in the general formula (1) represents a bivalent group represented by the chemical formula (Y2).

3. The compound mixture according to claim 1, wherein
at least two of R^{1A}, R^{2A}, R^{3A}, R^{4A}, R^{5A}, R^{6A}, R^{7A}, R^{8A}, R^{9A}, and R^{1A} in the general formula (1) represent a group different from a hydrogen atom, and any other than the at least two of R^{1A}, R^{2A}, R^{3A}, R^{4A}, R^{5A}, R^{6A}, R^{7A}, R^{8A}, R^{9A}, and R^{10A} represent a hydrogen atom, and
a sum of the carbon numbers of groups different from a hydrogen atom is at least 3.

4. The compound mixture according to claim 1, wherein
R^{3A} in the general formula (1) represents an alkoxy group having a carbon number of at least 1 and no greater than 8.

5. The compound mixture according to claim 1, wherein
the compound represented by the general formula (1) is a compound represented by chemical formula (HTM-1), and the compound represented by the general formula (2) is a compound represented by chemical formula (HTM-A),
the compound represented by the general formula (1) is a compound represented by chemical formula (HTM-2), and the compound represented by the general formula (2) is a compound represented by chemical formula (HTM-B),
the compound represented by the general formula (1) is a compound represented by chemical formula (HTM-3), and the compound represented by the general formula (2) is a compound represented by chemical formula (HTM-C), or
the compound represented by the general formula (1) is a compound represented by chemical formula (HTM-4), and the compound represented by the general formula (2) is a compound represented by chemical formula (HTM-D):

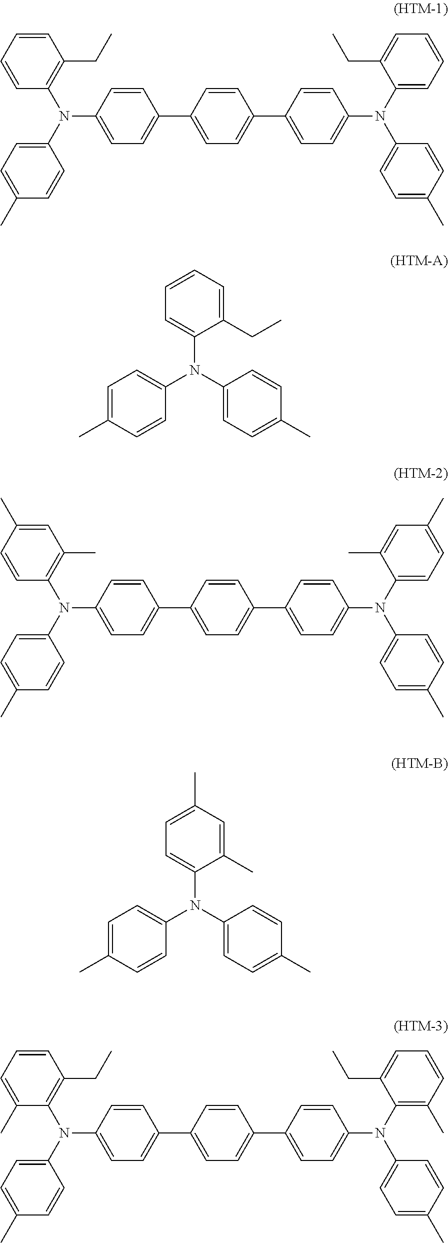

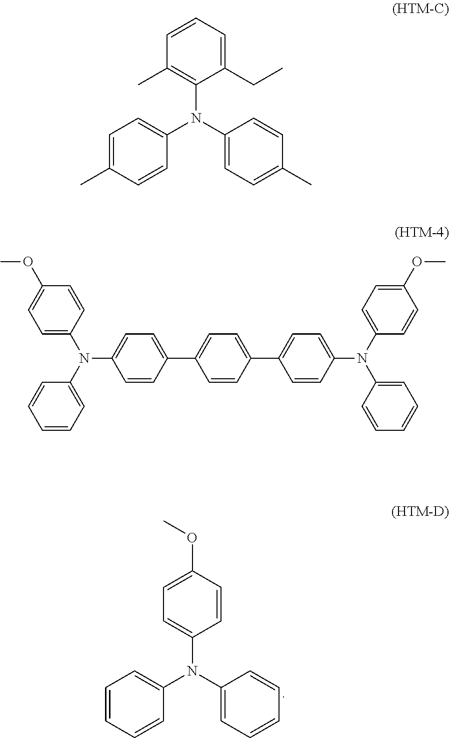

6. The compound mixture according to claim 1, wherein
the compound represented by the general formula (1) is a compound represented by chemical formula (HTM-5), and the compound represented by the general formula (2) is a compound represented by chemical formula (HTM-E):

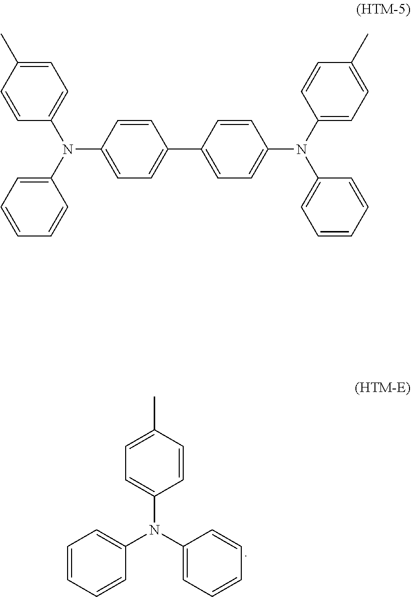

7. The compound mixture according to claim 1, wherein
the compound represented by the general formula (1) is a compound represented by chemical formula (HTM-6), and the compound represented by the general formula (2) is a compound represented by chemical formula (HTM-F):

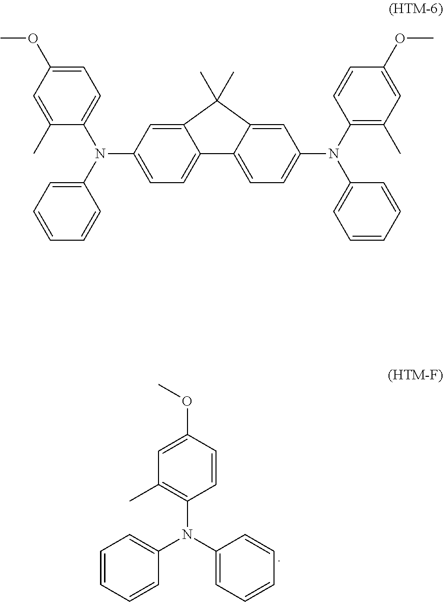

8. The compound mixture according to claim 1, wherein
a content ratio of the compound represented by the general formula (2) with respect to a total mass of the compound represented by the general formula (1) and the compound represented by the general formula (2) is at least 1.0% by mass and no greater than 10.0% by mass.

9. An electrophotographic photosensitive member comprising:
a conductive substrate; and
a photosensitive layer, wherein
the photosensitive layer contains at least a charge generating material, a hole transport material, and a binder resin, and
the hole transport material contains the compound mixture according to claim 1.

10. The electrophotographic photosensitive member according to claim 9, wherein
the binder resin includes a polyarylate resin, and
the polyarylate resin includes at least one repeating unit represented by general formula (10) and at least one repeating unit represented by general formula (11): 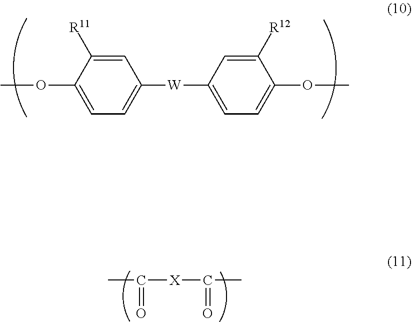
where, in the general formula (10), R¹¹ and R¹² each represent, independently of one another, a hydrogen atom or a methyl group, and W represents a bivalent group represented by general formula (W1), general formula (W2), or chemical formula (W3), and
in the general formula (11), X represents a bivalent group represented by chemical formula (X1), chemical formula (X2), or chemical formula (X3): 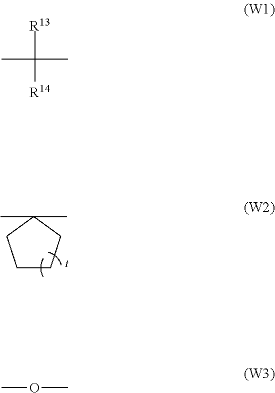
where in the general formula (W1), R¹³ represents a hydrogen atom or an alkyl group having a carbon number of at least 1 and no greater than 4, and R¹⁴ represents an alkyl group having a carbon number of at least 1 and no greater than 4, and
in the general formula (W2), t represents an integer of at least 1 and no greater than 3:

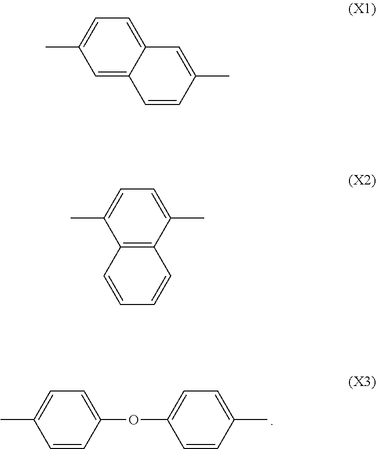

11. The electrophotographic photosensitive member according to claim 9, wherein
the binder resin includes a first polyarylate resin, a second polyarylate resin, or a third polyarylate resin,
the first polyarylate resin includes repeating units represented by chemical formula (10-1), chemical formula (11-X1), and chemical formula (11-X3): 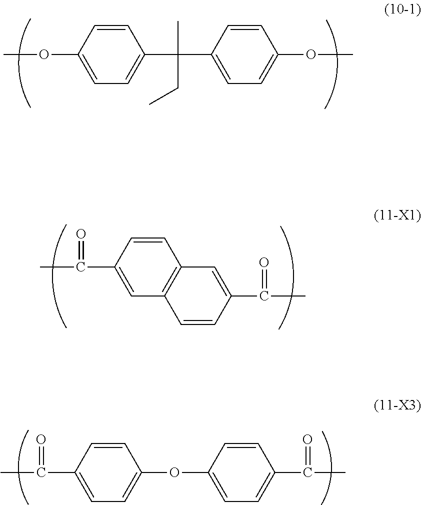
the second polyarylate resin includes repeating units represented by chemical formula (10-2), chemical formula (11-X1), and chemical formula (11-X3): 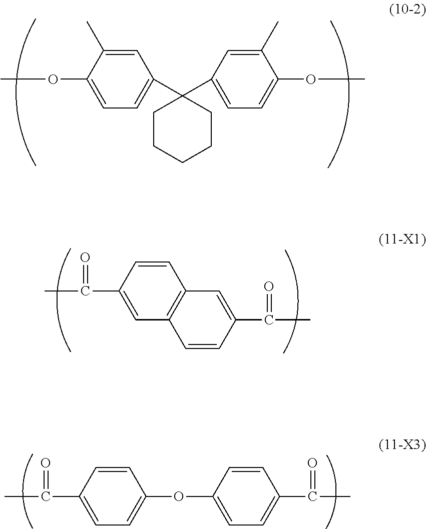
and
the third polyarylate resin includes repeating units represented by chemical formula (10-2), chemical formula (11-X1), and chemical formula (11-X2):

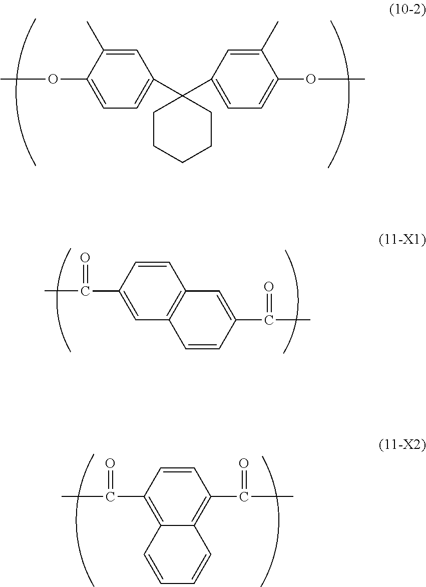

12. The electrophotographic photosensitive member according to claim 9, wherein
the binder resin includes a fourth polyarylate resin, and
the fourth polyarylate resin includes repeating units represented by chemical formula (10-1), chemical formula (10-3), and chemical formula (11-X3):

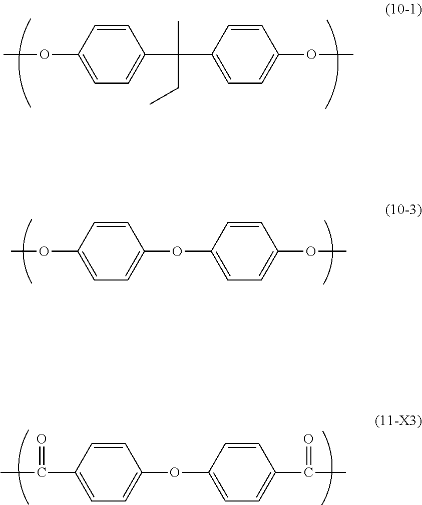

13. The electrophotographic photosensitive member according to claim 9, wherein
the photosensitive layer includes a charge generation layer and a charge transport layer,
the charge generation layer contains the charge generating material, and
the charge transport layer contains the hole transport material and the binder resin.

14. The electrophotographic photosensitive member according to claim 13, wherein
the charge transport layer further contains an electron acceptor compound, and
the electron acceptor compound includes a compound represented by general formula (20): 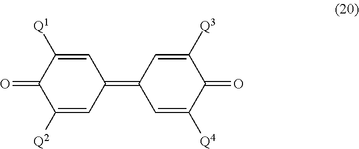
where, in the general formula (20), Q¹, Q², Q³, and Q⁴ each represent, independently of one another, an alkyl group having a carbon number of at least 1 and no greater than 6, an alkoxy group having a carbon number of at least 1 and no greater than 6, a cycloalkyl group having a carbon number of at least 5 and no greater than 7, or an aryl group having a carbon number of at least 6 and no greater than 14.

15. A production method for the compound mixture according to claim 1, comprising:
subjecting a liquid containing a compound represented by general formula (A) and a compound represented by general formula (B) to first stirring; and
subjecting, to second stirring, the liquid to which a compound represented by general formula (C) has been further added, wherein
the second stirring is performed without purifying the liquid after the first stirring, and
a mixture of the compound represented by the general formula (1) and the compound represented by the general formula (2) is obtained through the first stirring and the second stirring: 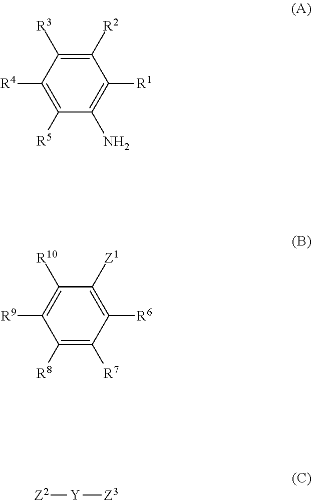
where R¹, R², R³, R⁴, and R⁵ in the general formula (A) respectively represent the same groups as R^{1A}, R^{2A}, R^{3A}, R^{4A}, and R^{5A} in the general formula (1);
R⁶, R⁷, R⁸, R⁹, and R¹⁰ in the general formula (B) respectively represent the same groups as R^{6A}, R^{7A}, R^{8A}, R^{9A}, and R^{10A} in the general formula (1);
Z¹ in the general formula (B) represents a halogen atom;
Y in the general formula (C) represents the same group as Y in the general formula (1); and
Z² and Z³ in the general formula (C) each represent a halogen atom.
